(19) United States
(12) Patent Application Publication
(10) Pub. No.: US 2025/0107547 A1
(43) Pub. Date: Apr. 3, 2025

(54) COLD GELLABLE RECOMBINANT BETA-LACTOGLOBULIN AND ASSOCIATED FOOD APPLICATIONS

(71) Applicant: BON VIVANT, Lyon (FR)

(72) Inventors: Arnaud MIMOUNI, Lyon (FR); Kelly MULDER, Lyon (FR); Helene BRIAND, Lyon (FR); Lena PIOLA, Lyon (FR)

(21) Appl. No.: 18/903,273

(22) Filed: Oct. 1, 2024

(30) Foreign Application Priority Data
Oct. 2, 2023 (EP) 23306689.3

(51) Int. Cl. A23C 21/08; A23C 1/12

(52) U.S. Cl. CPC A23C 21/08; A23C 1/12

(57) ABSTRACT

The present invention relates to a method for the preparation of a cold-gellable rBLG (recombinant β-lactoglobulin), a cold-gellable rBLG obtained from said process and a composition thereof, and the use of such cold-gellable rBLG for making animal and non-animal dairy products.

### CROSS-REFERENCE TO RELATED APPLICATIONS

This application claims the benefit of European Patent Application Serial No. 23306689.3 filed on Oct. 2, 2023. The contents of the aforementioned application is incorporated by reference herein.

### FIELD OF INVENTION

The present invention relates to a method for the preparation of a cold-gellable rBLG (recombinant β-lactoglobulin), a cold-gellable rBLG obtained from said process and a composition thereof, and the use of such cold-gellable rBLG for making non-animal and animal dairy products.

### BACKGROUND OF INVENTION

β-Lactoglobulin (BLG) is a whey protein present in many mammalians milk, and in particular in cow and sheep's milk. Whey proteins have been recognized as a protein source and contain biologically active components potentially beneficial to the human health.

β-Lactoglobulin (BLG) is the major whey protein, accounting for more than 40% of the total whey protein. Bovine β-lactoglobulin (BLG) is a protein of 162 amino acid residues with a molecular weight of 18.4 kDa. Because of its beneficial effects on human health, but also because of its physical properties and intrinsic characteristics, BLG is of direct interest in the food industry. Indeed, the amino acid content in BLG exceeds the Food and Agriculture nutritional intake recommendations both for children aged 2 to 5 and adults.

Different methods have been reported to enrich and texture dairy products from conventional milk protein. Overall, whey proteins can be functionalized to improve their texturing capacities. It is known from Mercade-Prieto, R. and Gunasekaran S. (Novel Food Processing: Effects on Rheological and Functional Properties, 2016, pages 147-186, “Gelation and thickening with globular proteins at low temperatures”) that whey proteins are denatured by heat treatment, and subsequent treatment with an acid or with salts induces the gelling properties of the obtained functionalized whey protein.

Heat treatment of native whey proteins leads to denaturation of the native secondary and tertiary structures, thus resulting in aggregation, and in some conditions to the formation of protein gel. This process is called thermal gelation.

When the concentration of the whey proteins is under the critical gel concentration, heating the protein solution leads to the formation of stable and soluble aggregates. The later are then able to form protein gel at low temperature, i.e. temperature below the denaturation temperature. This process also called cold-gelation is only possible as long as electrostatic repulsions between the aggregates are reduced. This can be obtained via the addition of salts such as calcium (salt-induced gelation) or by lowering the pH towards the isoelectric point (acid-induced gelation) after heat treatment.

Methods for producing denatured whey proteins capable of cold-gelation have been reported (US 2008/305235, U.S. Pat. No. 5,217,741, WO2006/034856 and WO2018/011392). In contrast, native whey proteins are not able to form gel at room temperature, i.e. at a temperature between 15 and 25° C., and more generally at a temperature below 70° C., even after addition of salts or under acidic condition (pH around the isoelectric point).

An alternative to the native whey proteins are recombinant whey proteins, which are currently used in dairy industry. In particular, recombinant β-lactoglobulin (rBLG) is used in dairy products to increase the concentration of said β-lactoglobulin (U.S. Pat. No. 5,795,611, US 2019/0216106, U.S. Pat. No. 9,924,728, WO2022/251263 and WO2022/239000). Consequently, rBLG are often used as the sole source of milk proteins in non-animal dairy analogue products.

However, to the Applicant knowledge, recombinant β-lactoglobulin BLG (rBLG) in native form does not have the properties of cold-gelation, that is necessary to produce fresh fermented products such as yogurts or cheese.

Therefore, there is a need in developing cold-gellable whey proteins, in particular cold-gellable recombinant β-lactoglobulin (rBLG) that have the ability to form a gel at low temperature, i.e. at a temperature below the denaturation temperature, i.e. at a temperature below 75° C., and preferably below 70° C. In parallel, it would be advantageous to use such whey proteins to increase the concentration of said whey proteins in dairy products, and in particular in non-animal dairy products.

### SUMMARY

The invention relates to a method for the preparation of cold-gellable recombinant β-lactoglobulin (rBLG) comprising the steps of:
a) Providing an aqueous solution of rBLG comprising from 3 to 15% w/w rBLG and having a pH comprised between 5 and 8, and
b) Heating the aqueous solution at a temperature from 65 to 95° C. for 1 to 30 minutes, to obtain the cold-gellable rBLG, the percentage being expressed in weight in relation to the total weight of the aqueous solution.

In one embodiment, the temperature of step a) according to the invention ranges from 1 to 60° C.

In one embodiment, step b) according to the invention is conducted under agitation at a stirring speed of 1 to 500 rpm when performed in batch.

In one embodiment, the method of the invention further comprises a step c) of cooling the heated aqueous solution at a temperature lower than 60° C.

In one embodiment, the method of the invention further comprises step d) of concentrating the heated aqueous solution.

In one embodiment, the method of the invention further comprises step e) of drying the heated aqueous solution.

In one embodiment, the aqueous solution of step a) comprises rBLG and at least one polysaccharide.

In one embodiment, the aqueous solution of step a) has the polysaccharide/rBLG ratio ranges from 1/3 to 1/30.

In one embodiment, rBLG is obtained from fungi, preferably from fungi of the genus Aspergillus.

Another object of the invention is a cold-gellable rBLG obtained from the method according to the invention.

In one embodiment, the cold-gellable-rBLG is in the form of aggregates, said aggregates having preferably a particle size ranging from 20 to 500 nm.

A further object of the invention is a dry cold-gellable rBLG composition comprising 45-95% w/w cold-gellable rBLG and at least one polysaccharide.

In one embodiment, the cold-gellable rBLG in the dry composition is in the form of aggregates, said aggregates having preferably a particle size ranging from 20 to 500 nm.

Another object of the invention is an aqueous solution of cold-gellable rBLG, comprising from 3 to 15% w/w cold-gellable rBLG, 0.1 to 5% w/w polysaccharide and water, the percentage being expressed in relation to the total weight of the aqueous solution.

Finally, another object of the invention is the use of a cold-gellable rBLG or of a dry cold-gellable rBLG composition or of an aqueous solution of cold-gellable rBLG for making non-animal and animal dairy products.

### Definitions

The present technology is explained in greater detail below. This description is not intended to be a detailed catalog of all the different ways in which the technology may be implemented, or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art in light of the instant disclosure in which variations and additions do not depart from the present technology. Hence, the following description is intended to illustrate some particular embodiments of the technology, and no to exhaustively specify all permutations, combinations and variations thereof.

The term “a” and “an” and “the” similar references as used herein refer to both the singular and the plural, otherwise indicated herein or clearly contradicted by context.

The recitation herein of numerical ranges by endpoints is intended to include all numbers subsumed within that range (e.g., a recitation of 1 to 5 includes 1, 1.25, 1.5, 1.75, 2, 2.45, 2.75, 3, 3.80, 4, 4.32, and 5).

The term “about” is used herein explicitly or not. Every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. For example, the term “about” in the context of a given value or range refers to a value or range that is within 20%, preferably within 15%, more preferably within 10%, more preferably within 9%, more preferably within 8%, more preferably within 7%, more preferably within 6%, and more preferably within 5% of the given value or range.

The expression “and/or” where used herein is to be taken as specific disclosure of each of the two specified features or components with or without the other. For example, “A and/or B” is to be taken as specific disclosure of each of (i) A, (ii) B and (iii) A and B, just as if each is set out individually herein. The term “or” as used herein should in general be construed non-exclusively. For example, an embodiment of “a composition comprising A or B” would typically present an aspect with a composition comprising both A and B. “Or” should, however, be construed to exclude those aspects presented that cannot be combined without contradiction (e.g., a composition pH that is between 9 and 10 or between 7 and 8).

The terms “from . . . to . . . ” and “between . . . and . . . ” as used herein must be understood as including the boundaries mentioned.

On the contrary, the expressions “greater than . . . ”, “more than . . . ”, “higher than . . . ”, “less than . . . ” and “lower than . . . ” as used herein do not include the boundaries mentioned.

The abbreviation “% w/w” means weight/weight percent. Other abbreviations can be used to define mass percentage, such as “wt %” (weight percent).

As used herein, the term “comprise” is used in its non-limiting sense to mean that items following the word are included, but items not specifically mentioned are not excluded.

The expression “native protein”, as used herein, refers to protein in its natural state with intact structure, i.e. the structure is not altered by chemical or physical treatments. The native state of the protein is its properly folded and assembled structure conferring stability and allowing functional activity.

The term “recombinant protein”, as used herein, refers to a protein produced by a genetically modified organism, wherein said organism does not produce said protein unless the genetic modification. The genetically modified organism, or “host” or “host cell” comprises a DNA sequence coding for the protein under control of regulatory elements allowing transcription and translation of said DNA into the recombinant protein.

According to the present technology, the genetically modified organism or host or host cell is modified with a DNA sequence coding for β-lactoglobulin (BLG), and refers to a cell into which a recombinant nucleotide sequence has been introduced. It should be understood that such terms are intended to refer not only to the particular subject cell but to the progeny of such a cell. Because certain modifications may occur in succeeding generations due to either mutation or environmental influences, such progeny may not, in fact, be identical to the parent cell, but are still included within the scope of the term “host” or “host cell” as used herein.

In some preferred embodiments, BLG can be a cow, human, sheep, goat, buffalo, camel, horse, donkey, lemur, panda, guinea pig, squirrel, bear, macaque, gorilla, chimpanzee, mountain goat, monkey, ape, cat, dog, wallaby, rat, mouse, elephant, opossum, rabbit, whale, baboons, gibbons, orangutan, mandrill, pig, wolf, fox, lion, tiger, echidna, or woolly mammoth BLG.

Advantageously, BLG is bovine BLG. The protein sequence of BLG as well as DNA sequences coding for said BLG are known, disclosed in the website: www.uniprot.org/uniprotkb/P0274/entry.

The expression “denatured protein”, as used herein, refers to protein for which the chemical architecture is disrupted. Proteins are highly organized structures having primary, secondary, tertiary and quaternary structures. Any change in the structural arrangement of the secondary, tertiary and/or quaternary structures corresponds to the denaturation of the protein altering its structure and rendering said protein incapable of performing its original assigned function.

The expression “functionalized protein”, as used herein, refers to protein that has undergone a treatment to modify its properties via chemical or physical treatment. Methods to functionalize proteins include chemical treatments such as salt washing, chemical hydrolysis and precipitation, and physical treatments such as heat treatment, high/low pressure application, sonication or shearing.

The expression “cold-gellable” proteins corresponds to proteins having the capacity to form a gel at a temperature below the denaturation temperature. As used herein, gel refers to a semi-solid system in which a liquid is dispersed within a solid-like network. The network is able to trap the liquid, giving to the material properties ranging from soft and weak to hard and tough, or properties between a liquid or a solid state. Gels exhibit elasticity (like solid) and fluidity (like liquid) depending on the forces that are applied. In the context of protein gels, gel refers to a three-dimensional network formed by protein molecules that traps water and other molecules.

The expression “room temperature” when used to characterize the temperature of a particular step in a method, refers to the temperature within enclosed space at which reactions can be carried out without device to maintain constant temperature. In some embodiments, a room temperature corresponds to a temperature from 15 to 25° C., preferentially a temperature from 18 to 25° C., and more preferentially from 20 to 25° C.

The expression “room temperature” when used to characterize the properties of a compound, such as “gellable at room temperature”, means from 15 to 25° C.

The expression “food product” as used herein refers to a composition that can be ingested by humans or animals, including domesticated animals (e.g., dogs, cats), farm animals (e.g., cows, pigs, horses), and wild animals (e.g., non-domesticated predatory animals). In various embodiments, the food products provided herein meet standards for food safety required by the U.S. Food and Drug Administration (FDA), the U.S. Department of Agriculture, the European Food Safety Authority, and/or other state or region food regulatory agencies. The expression “food product” includes compositions that can be combined with or added to other ingredients to make compositions that can be ingested by humans or animals. According to the invention, examples of food products are dairy products.

The expression “dairy product”, also called “animal dairy product”, as used herein refers to milk (e.g., whole milk [at least 3.25% milk fat], partly skimmed milk [from 1% to 2% milk fat], skim milk [less than 0.2% milk fat], cooking milk, condensed milk, flavored milk, goat milk, sheep milk, dried milk, evaporated milk, milk foam), and products derived from milk, including but not limited to yogurt (e.g., whole milk yogurt [at least 6 grams of fat per cup], low-fat yogurt [between 2 and 5 grams of fat per cup], nonfat yogurt [less than 0.5 percent milk fat by weight], Greek yogurt [strained yogurt with whey removed], whipped yogurt, stirred yogurt, goat milk yogurt, Labneh [labne], sheep milk yogurt, yogurt drinks [e.g., whole milk Kefir, low-fat milk Kefir], Lassi), cheese (e.g., whey cheese such as ricotta and mozzarella, semi-soft cheese such as Havarti and Munster, medium-hard cheese such as Swiss and Jarlsberg, hard cheese such as Cheddar and Gouda, soft ripened cheese such as Brie and Camembert, cottage cheese, cream cheese, curd), cream (e.g., whipping cream, coffee whitener, coffee creamer, sour cream, crème fraiche), frozen confections (e.g., ice cream, smoothie, milk shake, frozen yogurt, sundae), fruit preparation, butter, infant formula, weight loss beverages, nutritional beverages, pudding, buttermilk, milk protein concentrate, whey protein concentrate, whey protein isolate, casein concentrate, casein isolate, skim milk powder, whole milk powder, nutritional supplements, texturizing blends, flavoring blends, or coloring blends. The expressions “dairy product” or “animal dairy product” or even “animal product”, as used herein, refer to product or dairy product that comprises components of animal origin, or that comprises both components of animal origin and component of non-animal origin.

The expression “high protein dairy product”, as used herein, refers to protein enriched dairy product for which the total of protein concentration exceeds 5%, or for which the protein concentration is higher than that of standard products sold on the market and not considered protein rich. Such high protein dairy products are for example (but not limited to) high proteins yogurts, high protein UHT (ultra heat treatment) drinks, high protein fruit preparations, high protein cream cheeses, high protein snacks, high protein bites, high protein cereal bars, high protein ready to drink milk, high protein milk beverages or high protein beverages.

The expression “non-animal-derived”, as used herein, refers to a component (e.g., protein, lipid, carbohydrate) that is not native to an animal cell, like a recombinant protein produced by a microbial host or by a plant cell for instance. In some embodiments, the expression “non-animal-derived” refers to components derived from naturally occurring or modified plants, algae, fungi, or microbes. Similarly, the expressions “non-animal product” and “non-animal dairy product”, as used herein, refer to a product or a dairy product that does not comprise component of animal origin.

According to the present invention, “non-animal dairy products”, also called “dairy-like products”, relate to products that do not comprise milk or milk protein of animal origin. Advantageously, dairy-like products comprise milk of vegetal origin such as plant-based milk, and preferably selected from soy, oat, almond and coconut milk, or proteins extracted from plants, algae, fungi or microbes.

The expression “animal-derived”, as used herein, refers to component, such as a milk protein, produced by an animal, for instance, a cow. In some embodiments, the term “animal-derived” refers to a mammal-produced milk or a mammal-produced dairy product.

### DETAILED DESCRIPTION

The invention relates to a method for the preparation of a cold-gellable rBLG comprising the steps of:
a) Providing an aqueous solution of rBLG comprising from 3 to 15% w/w rBLG and a pH comprised between 5 and 8, and
b) Heating the rBLG aqueous solution at a temperature from 65 to 95° C. for 1 to 30 minutes, to obtain the cold-gellable rBLG, the percentage being expressed in weight in relation to the total weight of the aqueous solution.

In the description, the expressions “functionalized cold-gellable rBLG”, “functionalized rBLG” and “cold-gellable rBLG” define the rBLG that has undergone treatment to modify its properties in the aim to obtain rBLG having the desired gelling properties according to the invention.

Recombinant β-Lactoglobulin (rBLG)

Recombinant β-lactoglobulin (rBLG) is obtained via a) culturing a genetically modified organism under conditions suitable for production and/or secretion of the rBLG, and b) isolating said recombinant protein from the culture.

Methods for the production of rBLG are known, and disclosed for example in Food Research International, 2023, 163, 112131, Mol. Biotechnol. 2016, 58, 10, 605-618 and Protein Eng; 1997, 10, 11, pages 1339-1345.

Genetically modified organisms, or host, for the production of rBLG are selected among yeast, bacteria and fungi.

In one embodiment, the host is a yeast strain, and in particular a yeast selected from the strains Kluyveromyces sp., Pichia sp., Saccharomyces sp., Tetrahymena sp., Yarrowia sp., Hansenula sp., Blastobotrys sp., Candida sp., Zygosaccharomyces sp., Debaryomyces sp., Saccharomyces cerevisiae, and Pichia pastoris.

In another embodiment, the host is a bacterial cell. Non limiting examples of bacterial cells suitable for the production of rBLG according to the invention are bacterial cells selected from the species of Acetobacter suboxydans, Acetobacter xylinum, Actinoplane missouriensis, Bacillus cereus, Bacillus coagulans, Bacillus licheniformis, Bacillus stearothermophilus, Bacillus subtilis, Escherichia coli, Lactobacillus bulgaricus, Lactococcus lactis, Lactococcus lactis Lancefield Group N, Leuconostoc citrovorum, Leuconostoc dextranicum, Leuconostoc mesenteroides strain NRRL B-512 (F), Micrococcus lysodeikticus, Streptococcus cremoris, Streptococcus lactis, Streptococcus lactis subspecies diacetylactis, Streptococcus thermophilus, Streptomyces chattanoogensis, Streptomyces griseus, Streptomyces natalensis, Streptomyces olivaceus, Streptomyces olivochromogenes, Streptomyces rubiginosus, and Xanthomonas campestris. Preferably, the host cell is selected from Bacillus cereus, Bacillus coagulans, Bacillus licheniformis, Bacillus stearothermophilus and Bacillus subtilis. Advantageously, the host cell is Bacillus Subtilis when the host is a bacterial cell.

Yet, in another embodiment, the host is selected among fungi, and for example selected among Aspergillus niger, Aspergillus niger var. awamori, Aspergillus oryzae, Candida guilliermondii, Candida lipolytica, Candida pseudotropicalis, Candida utilis, Endothia parasitica, Eremothecium ashbyii, and Fusarium moniliforme.

In preferred embodiments, the fungus is selected among filamentous fungi, and preferably belong to the genus Aspergillus and Trichoderma. More preferably, the host is selected from Aspergillus species, particularly Aspergillus niger, Aspergillus niger var. awamori, and Aspergillus oryzae.

In a particular embodiment, rBLG is isolated form the culture of recombinant filamentous fungi (Microorganisms. 2022, 10, 4, 753, and U.S. Pat. No. 9,924,728), more particularly a recombinant Aspergillus specie selected from Aspergillus niger, Aspergillus niger var. awamori and Aspergillus oryzae.

The recombinant β-lactoglobulin (rBLG) protein sequence can be identical or similar to a BLG sequence from cow, human, sheep, goat, buffalo, camel, horse, donkey, lemur, panda, guinea pig, squirrel, bear, macaque, gorilla, chimpanzee, mountain goat, monkey, ape, cat, dog, wallaby, rat, mouse, elephant, opossum, rabbit, whale, baboons, gibbons, orangutan, mandrill, pig, wolf, fox, lion, tiger, echidna, or woolly mammoth. By “similar to a BLG sequence”, it is understood that the rBLG protein sequence has a sequence homology of at least 50%, 60%, 70%, 80%, or 90% with said BLG sequence.

Alternatively, the recombinant β-lactoglobulin (rBLG) protein sequence can be a fragment or a variant with at least 70%, 80%, or 90% sequence identity to a BLG sequence from cow, human, sheep, goat, buffalo, camel, horse, donkey, lemur, panda, guinea pig, squirrel, bear, macaque, gorilla, chimpanzee, mountain goat, monkey, ape, cat, dog, wallaby, rat, mouse, elephant, opossum, rabbit, whale, baboons, gibbons, orangutan, mandrill, pig, wolf, fox, lion, tiger, echidna, or woolly mammoth.

In some embodiments, the recombinant β-lactoglobulin (rBLG) can be a blend of different rBLG. In this case, the blend of different rBLG comprises advantageously at least one of a full length rBLG sequence identical to a rBLG sequence from cow, human, sheep, goat, buffalo, camel, horse, donkey, lemur, panda, guinea pig, squirrel, bear, macaque, gorilla, chimpanzee, mountain goat, monkey, ape, cat, dog, wallaby, rat, mouse, elephant, opossum, rabbit, whale, baboons, gibbons, orangutan, mandrill, pig, wolf, fox, lion, tiger, echidna, or woolly mammoth. According to other embodiments, at least one of the rBLG sequence of the blend is a fragment or variant as defined above. Yet, in other embodiments, at least one of the rBLG sequence of the blend is modified, truncated or trimmed relative to a full length rBLG sequence from cow, human, sheep, goat, buffalo, camel, horse, donkey, lemur, panda, guinea pig, squirrel, bear, macaque, gorilla, chimpanzee, mountain goat, monkey, ape, cat, dog, wallaby, rat, mouse, elephant, opossum, rabbit, whale, baboons, gibbons, orangutan, mandrill, pig, wolf, fox, lion, tiger, echidna, or woolly mammoth.

When the recombinant β-lactoglobulin (rBLG) is a blend of different rBLG, it is understood that rBLG can have been produced from different genetically modified organisms. However, the genetically modified organisms, although different, can be in the same cell culture medium (co-culture). The genetically modified organisms can alternatively be in different culture media. Preferably, only one genetically modified organism produces the blend of rBLG.

Preparation of a Functionalized (Cold-Gellable) Recombinant β-Lactoglobulin (rBLG)

According to the invention, the method for the preparation of a cold-gellable rBLG comprises several steps.

### Step a)

The first step (step a) is to provide an aqueous solution of rBLG, said solution comprising from 3 to 15% w/w of rBLG and having a pH of 5 to 8.

In one embodiment, the aqueous solution according to the invention is obtained by dissolving native rBLG in water, preferentially in purified water or demineralized water.

Advantageously, the dissolution of native rBLG is achieved at a temperature comprised between 1 and 60° C., preferably at a temperature comprised between 1° and 50° C., more preferably at a temperature comprised between 15 and 40° C. In a preferred embodiment, the dissolution of native rBLG in water is achieved at room temperature, i.e. at a temperature comprised between 15 and 25° C.

Advantageously, the native rBLG to be dissolved is a purified dehydrated rBLG. Such rBLG proteins can be obtained by culturing a genetically modified organism and isolating said recombinant protein or can be purchased.

In other embodiments, the aqueous solution of rBLG is the liquid solution obtained from the rBLG purification process after fermentation. In other words, the aqueous solution of rBLG is the liquid solution obtained from the downstream process. Thus, according to these embodiments, the aqueous solution of rBLG is preferably the retentate of the ultrafiltration process, that is to say the retentate obtained after concentration and diafiltration.

The aqueous solution according to the invention comprises from 3 and 15% w/w of rBLG, the percentage being expressed in weight in relation to the total weight of the aqueous solution. The person of ordinary skill in the art knows to determine the required quantity of rBLG to afford such concentration depending on the purity of the rBLG and the volume of the solution.

Advantageously, the aqueous solution of rBLG comprises at least 1% w/w of rBLG, preferably at least 2% w/w, more preferably at least 2.5% w/w, and even more preferably at least 3% w/w of rBLG, the percentage being expressed in weight in relation to the total weight of the aqueous solution.

Advantageously, the rBLG content in the aqueous solution is comprised between 1 and 20% w/w, preferably between 2 and 20% w/w, more preferably between 2 and 18% w/w, even more preferably between 2 and 17% w/w, still better between 2 and 16% w/w, and even still better between 2 and 15% w/w, the percentage being expressed in weight in relation to the total weight of the aqueous solution. More preferably, the aqueous solution of rBLG comprises from 3 to 15% w/w of rBLG, preferably from 4 to 15% w/w, more preferably from 5 to 15% w/w. Still better, the aqueous solution of rBLG comprises from 6 to 15% w/w of rBLG, preferably from 6 to 12% w/w, more preferably from 6 to 10% w/w, even more preferably from 6 to 9% w/w, end even more preferably from 6 to 8% w/w of rBLG, the percentage being expressed in weight in relation to the total weight of the aqueous solution.

Advantageously, the aqueous solution of rBLG comprises from 3 to 15% w/w, preferably from 3 to 12% w/w, more preferably from 3 to 10% w/w, preferably from 3 to 9% w/w or preferably from 3 to 8% w/w, and more preferably from 3 to 7% w/w of rBLG, the percentage being expressed in weight in relation to the total weight of the aqueous solution.

Advantageously, the aqueous solution comprises around 5% w/w, around 6% w/w, around 7% w/w, around 8% w/w or around 9% w/w of rBLG, the percentage being expressed in weight in relation to the total weight of the aqueous solution.

The pH of the aqueous solution is of importance, and has to be maintained between 5 and 8.

In one embodiment, the pH of the aqueous solution is higher than or equal to 5, preferably higher or equal to 6.

In one embodiment, the pH of the aqueous solution is lower than or equal to 8, preferably lower than or equal to 7.

In one embodiment, the pH of the aqueous solution is comprised between 5 and 8, preferably between 6 and 8, more preferably between 6 and 7, and even more preferably between 6.5 and 7. Advantageously, the pH of the aqueous solution comprising rBLG is around 6.5, or around 6.6 or around 6.7.

pH adjustment of the aqueous solution is performed according to known technics in the art, particularly via the addition of acids or bases into said solution. It is understood that acids and bases can be added in the form of an aqueous solution or in the form of salts. Examples of acids and bases that can be used to adjust the pH of the aqueous solution comprising rBLG according to the invention are acidic acid, adipic acid, ammonium aluminum sulphate, ammonium bicarbonate, ammonium carbonate, ammonium citrate dibasic, ammonium citrate monobasic, ammonium hydroxide, ammonium phosphate dibasic, ammonium sulphate monobasic, calcium acetate, calcium acid pyrophosphate, calcium carbonate, calcium chloride, calcium citrate, calcium fumarate, calcium gluconate, calcium hydroxide, calcium lactate, calcium oxide, calcium phosphate dibasic, calcium phosphate monobasic, calcium phosphate tribasic, calcium sulphate, carbon dioxide, citric acid, cream of tartar, fumaric acid, gluconic acid, glucono-delta-lactone, hydrochloric acid, lactic acid, magnesium carbonate, magnesium citrate, magnesium fumarate, magnesium hydroxide, magnesium oxide, magnesium phosphate, magnesium sulphate, malic acid, manganese sulphate, metatartaric acid, phosphoric acid, potassium acid tartrate, potassium aluminum sulphate, potassium bicarbonate, potassium carbonate, potassium chloride, potassium citrate, potassium fumarate, potassium hydroxide, potassium lactate, potassium phosphate dibasic, potassium phosphate tribasic, potassium pyrophosphate tetrabasic, potassium sulphate, potassium tartrate, potassium tripolyphosphate, sodium acetate, sodium acid pyrophosphate, sodium acid tartrate, sodium aluminum phosphate, sodium aluminum sulphate, sodium bicarbonate, sodium bisulphate, sodium carbonate, sodium citrate, sodium fumarate, sodium gluconate, sodium hexametaphosphate, sodium hydroxide, sodium lactate, sodium phosphate dibasic, sodium phosphate monobasic, sodium phosphate tribasic, sodium potassium hexametaphosphate, sodium potassium tartrate, sodium potassium tripolyphosphate, sodium pyrophosphate tetrabasic, sodium tripolyphosphate, sulphuric acid, sulphurous acid, and tartaric acid.

The aqueous solution comprising rBLG can further comprises one or more polysaccharides. According to the invention, the term “polysaccharides” refers to linear or branched polymers composed of monosaccharide units linked by glycosidic bonds. Monosaccharides have general formula (CH₂O)ₙ with n the number of monosaccharides and being of at least three. Examples of monosaccharides are trioses, tetroses, pentoses, hexoses, heptoses. Particularly, polysaccharides are polymers of galactose, glucose, mannose in different proportions. Polysaccharides are preferably polymers of natural origin, and in particular produced by plants, fungi, yeasts or bacteria, possibly modified during or after extraction form the producing organism.

According to some embodiments, the aqueous solution comprising rBLG does not comprise a polysaccharide.

According to some other embodiments, the aqueous solution comprising rBLG may further comprise at least one polysaccharide.

When it is present, the polysaccharide is advantageously of fungal origin, and preferably isolated from a filamentous fungi selected from the group of species of Aspergillus and Trichoderma.

In another particular embodiment, the polysaccharide is produced by the same organism as the genetically modified organism producing the rBLG as defined above.

Yet, in another particular embodiment, the polysaccharide and rBLG are obtained as a mixture when isolating rBLG from the culture of the genetically modified organism producing rBLG as defined above.

In one preferred embodiment, polysaccharides, when they are present in the aqueous solution of rBLG, are heteropolysaccharides. Preferably, heteropolysaccharides comprise galactose and mannose, analysis of heteropolysaccharides having been performed by spectrophotometry and chromatography after hydrolysis of said heteropolysaccharides. Advantageously, the mannose/galactose ratio in polysaccharides, present in the aqueous solution of rBLG, ranges from 0.5/1 to 5/1, preferably from 0.5/1 to 4/1, more preferably from 1/1 to 3/1, or more preferably from 1/1 to 2/1, and still better from 1.5/1 to 2/1.

In another preferred embodiment, polysaccharides, when they are present in the aqueous solution of rBLG, comprise heteropolysaccharides as defined above, and further comprise glucose. Advantageously, when present, the glucose can be found in a free form or in the form of β-glucan.

The glucose content can be determined by spectrophotometry and chromatography, optionally after hydrolysis of β-glucan. Advantageously, the glucose content in polysaccharides, when they are present in the aqueous solution of rBLG, is less than 30% w/w in relation to the total weight of polysaccharides, preferably less than 25% w/w and more preferably less than 20% w/w in relation to the total weight of polysaccharides. Preferably, when present, the glucose content is comprised between 0.001 and 20% w/w in relation to the total weight of polysaccharides, preferably between 0.01 and 18% w/w, more preferably between 0.5 and 16% w/w, even more preferably between 1 and 15% w/w in relation to the total weight of polysaccharides. Yet, when present, the glucose content in polysaccharides is comprised between 3 and 15% w/w, more preferably between 5 and 15% w/w, even more preferably between 8 and 14% w/w in relation to the total weight of polysaccharides.

The aqueous solution of rBLG can comprise said rBLG and one or more polysaccharides. Preferably, the polysaccharide content in the aqueous solution ranges from 0 to 50% w/w in relation to the dry matter of the aqueous solution.

In one embodiment, the polysaccharide content in the aqueous solution is lower than 40% w/w, and preferably lower than 30% w/w in relation to the dry matter of the aqueous solution.

In one embodiment, the polysaccharide content ranges from 0 to 30% w/w, from 2 to 30% w/w, or from 3 to 30% w/w, or from 5 to 30% w/w, or from 8 to 30% w/w or from 8 to 25% w/w, preferably from 9 to 22% w/w, and more preferably from 10 to 20% w/w, or from 10 to 17% w/w, or from 10 to 15% w/w, or from 10 to 12% w/w, in relation to the dry matter of the aqueous solution. Advantageously, the polysaccharide content in the aqueous solution of rBLG is around 9% w/w, around 10% w/w, around 15% w/w or around 20% w/w in relation to the dry matter of the aqueous solution.

In one embodiment, the polysaccharide content is lower than or equal to 3% w/w, preferably lower than or equal to 2% w/w, and more preferably lower than or equal to 1% w/w, in relation to the dry matter of the aqueous solution.

The content of the polysaccharide in the aqueous solution of rBLG can also be defined by a polysaccharide/rBLG ratio.

In one embodiment, the polysaccharide/rBLG ratio is lower or equal to 1/2, and preferably equal or lower than 1/3.

Advantageously, the aqueous solution comprising rBLG and polysaccharides has a polysaccharide/rBLG ratio ranging from 1/30 to 1/2, preferably from 1/30 to 1/3, more preferably from 1/25 to 1/3, even more preferably from 1/20 to 1/3, and still better from 1/10 to 1/3, and even still better from 1/15 to 1/3, or preferably between 1/15 and 1/5.

Advantageously, the aqueous solution according to the invention comprising rBLG and polysaccharide has a polysaccharide/rBLG ratio of around 1/6, around 1/5 or around 1/4.

The aqueous solution of rBLG may further comprise sugars, said sugars being different from polysaccharides defined above. Addition of sugars to the aqueous solution of rBLG may improve the control aggregation of rBLG during the preparation of functionalized rBLG. The additional sugars are in particular mono- and/or disaccharides. Non limiting examples of mono- and disaccharides are sucrose, glucose, fructose and maltose.

In one embodiment, the aqueous solution of rBLG comprises sugars as defined above, and preferably with a sugar concentration lower than 1% w/w, or even lower than 0.5% w/w, the percentage being expressed in weight in relation to the total weight of the aqueous solution. In a preferred embodiment, the aqueous solution comprising rBLG does not comprise additional sugars, except from the residual sugars from the isolation of rBLG from the culture of the genetically modified organism producing the rBLG.

When present, the quantity of additional sugars can be defined by a sugars/rBLG ratio. Preferably, the sugars/rBLG ratio in the aqueous solution of rBLG is lower than 1/20, preferably lower than 1/50, more preferably lower than 1/75, and even ore preferably lower than 1/100. Advantageously, the sugar/rBLG ratio is lower than 1/110, lower than 1/120, or even lower than 1/130. In a preferred embodiment, the sugar/rBLG ratio is comprised between 1/120 to 1/130.

The aqueous solution of rBLG may eventually further comprise one or more lipids. Such lipids are preferably chosen from linoleic acid, oleic acid, stearic acid and palmitic acid. In one embodiment, the rBLG aqueous solution comprises lipids, and preferably with a concentration lower than 1% w/w, or even lower than 0.5% w/w, the percentage being expressed in weight in relation to the total weight of the aqueous solution. In one embodiment, the aqueous solution does not comprise additional lipids except from the residual lipids from the isolation of rBLG from the culture of the genetically modified organism producing the rBLG.

### Step b)

Following the preparation of the aqueous solution comprising rBLG as defined above, a heating step (step b) is performed to afford the functionalized cold-gellable rBLG.

The heat treatment is carried out at a temperature higher or equal to the denaturation temperature of said rBLG. Thus, according to the invention, the temperature of the heating step (step b) is comprised between 65 and 95° C., preferably between 7° and 95° C., more preferably between 75 and 95° C.

In one embodiment, the temperature of the heating step (also called heat treatment) is higher than or equal to 60° C., preferably higher than or equal to 65° C., more preferably higher than or equal to 70° C., and even more preferably higher than or equal to 71° C.

In one embodiment, the temperature of the heat treatment is lower than or equal to 100° C., and preferably lower than or equal to 95° C.

In one embodiment, the temperature of the heat treatment is carried out at a temperature comprised between 72 and 95° C., preferably between 75 and 95° C., more preferably between 78 and 95° C. In another embodiment, the temperature of the heat treatment is comprised between 78 and 92° C., preferably between 8° and 92° C., more preferably between 8° and 91° C., or more preferably between 81 and 90° C., even more preferably between 82 and 88° C., and still better between 83 and 86° C. Advantageously, the heat treatment of step b) is carried out at a temperature around 77° C., around 80° C., around 83° C., or around 85° C.

During the heat treatment, the aqueous solution of rBLG is preferably stirred under moderate agitation, and more particularly at a rotational speed of 1 to 500 rpm (rotation par minute) when the method is carried out in batch. In this case, the stirring is achieved for example by using rotating blade or magnetic stirrer. It is understood that the person of ordinary skill in the art will know what is the appropriate stirring method to afford the desired rotational speed depending on the container and the volume of the aqueous solution.

In one embodiment, the method according to the invention is carried out in batch, and the rotational speed is of 10 to 500 rpm, preferably of 20 to 500 rpm, more preferably of 50 to 500 rpm. In preferred embodiments, the rotational speed is of 50 to 450 rpm, preferably of 50 to 400 rpm, more preferably of 50 to 350 rpm, even more preferably of 100 to 300 rpm, and even more preferably of 100 to 250 rpm. Advantageously, the rotational speed is of around 120 rpm, 150 rpm, 170 rpm or 200 rpm when the method is performed in batch.

The rotational speed can also be defined as a peripheral speed. Peripheral speed is defined by the linear velocity of the propeller at the end of the blade. According to this embodiment, the peripheral speed is preferably between 0.5 and 20 m/s, more preferably between 1 and 18 m/s, more preferably between 2 and 15 m/s, even more preferably between 5 and 12 m/s, and still better between 7 and 10 m/s.

In step b), the heat treatment of the rBLG aqueous solution according to the invention lasts for from 1 to 30 minutes.

Advantageously, the heat treatment in step b) is carried out from 1 to 20 minutes, preferably from 5 to 30 minutes, more preferably from 5 to 20 minutes, and more preferably from 2 to 20 minutes, from 3 to 15 minutes, and even more preferably from 5 to 15 minutes. Advantageously, the heat treatment of the aqueous solution comprising rBLG is around 5 minutes, around 8 minutes, around 10 minutes, around 12 minutes, or around 15 minutes.

In some embodiments, the heat treatment can be carried out following a continuous process. This is notably the case when high quantity of rBLG is handled at technical scale. According to the invention, technical scale means above 1 kg of rBLG processed per hour. When the heat treatment is a continuous process, plate heat exchangers and/or tubular heat exchangers are used. The time of the reaction corresponds to the residence time holding tubes. The person of ordinary skills in the art is familiar with the continuous process and will be able to define the appropriate heat apparatus as well as the reaction time.

The two-step sequence, step a) of providing an aqueous solution of rBLG and step b) of heating the said aqueous solution according to the invention allow the formation of functionalized rBLG or cold-gellable rBLG, also called functionalized cold-gellable rBLG.

### Additional Steps

The functionalized (cold-gellable rBLG) aqueous solution can further undergo several treatments such as cooling step (step c) and/or concentration step (step d) and/or drying step (step e).

### Step c)

The method for the preparation of cold-gellable rBLG according to the invention can further comprise an additional step c) of cooling the heated aqueous solution.

The cooling temperature of the aqueous solution of cold gellable rBLG is advantageously lower than the denaturation temperature of rBLG, and preferably lower than or equal to 60° C.

In one embodiment, the heated aqueous solution is cooled to a temperature of 50° C. or lower, preferably to a temperature of 45° C. or lower, preferably to a temperature of 40° C. or lower, preferably to a temperature of 35° C. or lower, and more preferably to a temperature of 30° C. or lower.

In one embodiment, the aqueous solution of cold gellable rBLG is cooled to a temperature comprised between 1 and 30° C., preferably between 1 and 28° C., more preferably between 2 and 25° C., more preferably between 5 and 25° C., even more preferably between 5 and 22° C., and still better between 5 and 20° C. More preferably, the aqueous solution of cold gellable rBLG is cooled to a temperature comprised between 5 and 15° C., preferably between 5 and 12° C., more preferably between 5 and 10° C.

### Step d)

The method for the preparation of cold-gellable rBLG according to the invention can further comprise an additional step d) of concentrating the heated aqueous solution.

The heated aqueous solution comprising functionalized cold-gellable rBLG can also be concentrated. Concentration of the heated aqueous solution is performed according to the well-known methods of the technical field. Such methods comprise centrifugation, dialysis, precipitation or salting out, filtration or chromatography. The person of ordinary skill in the art will be able to choose the appropriate method, and to apply the appropriate conditions.

### Step e)

The method according to the invention can further comprise a step of drying, thus affording a dry cold-gellable rBLG.

Suitable drying methods are for examples freeze-drying, spray drying and supercritical drying. The person of ordinary skill in the art will know to choose the drying method of choice and suitable parameters to afford the dry cold-gellable rBLG without altering its properties and in particular its gelling properties.

According to the invention, steps of cooling (step c), concentrating (step d) and drying (step e) the aqueous solution comprising functionalized (cold-gellable) rBLG are optional and can be performed independently of each other. When performed, steps c), d) and e) are preferably done after the preparation of the cold-gellable rBLG, i.e after step b).

Optional steps c) of cooling, d) of concentrating and e) of drying can be done alone or as a combination. Thus, it is understood that step c) can be performed before or after step d). Also, step d) can be performed before or after step c).

### Modes of Carrying the Invention

In one embodiment, the method for the preparation of cold-gellable rBLG comprises the steps of:
a) providing an aqueous solution of rBLG comprising from 3 to 15% w/w rBLG, and a pH comprised between 5 and 8, and
b) heating the aqueous solution at a temperature from 65 to 95° C., for 1 to 30 minutes.

In one embodiment, the method for the preparation of cold-gellable rBLG comprises the steps of:
a) providing an aqueous solution of rBLG comprising from 3 to 9% w/w rBLG, and a pH comprised between 5 and 8, and
b) heating the aqueous solution at a temperature from 65 to 95° C., preferably from 72 to 95° C. for 1 to 30 minutes.

In one embodiment, the method for the preparation of cold-gellable rBLG comprises the steps of:
a) providing an aqueous solution of rBLG comprising from 3 to 15% w/w rBLG, preferably from 3 to 9% w/w rBLG, and a pH comprised between 5 and 8, and
b) heating the aqueous solution at a temperature from 75 to 90° C., for 1 to 30 minutes, preferably from 1 to 20 minutes.

In one embodiment, the method for the preparation of cold-gellable rBLG comprises the steps of:
a) providing an aqueous solution of rBLG comprising from 6 to 15% w/w rBLG, and a pH comprised between 5 and 8, preferably at a pH comprised between 6 and 7, and
b) heating the aqueous solution at a temperature from 72 to 95° C., for 1 to 30 minutes.

In one embodiment, the method for the preparation of cold-gellable rBLG comprises the steps of:
a) providing an aqueous solution of rBLG comprising from 3 to 7% w/w rBLG, and a pH comprised between 5 and 8, preferably between 6 and 7, and
b) heating the aqueous solution at a temperature from 72 to 95° C., for 1 to 30 minutes.

In one embodiment, the method for the preparation of cold-gellable rBLG comprises the steps of:
a) providing an aqueous solution of rBLG comprising from 3 to 7% w/w rBLG, and a pH comprised between 5 and 8, and
b) heating the aqueous solution at a temperature from 72 to 95° C. for 1 to 30 minutes.

In one embodiment, the method for the preparation of cold-gellable rBLG comprises only steps a) and b). In another embodiment, the method of the invention comprises the steps a), b) and c). In another embodiment, the method of the invention comprises the steps a), b), c), and d). Yet, in another embodiment, the method of the invention comprises the steps a), b), c), d), and e). Still, in another embodiment, the method of the invention comprises the steps a), b) and d). In another embodiment, the method of the invention comprises the steps a), b) and e). Yet, in another embodiment, the method of the invention comprises the steps a), b), c) and e). Still, in another embodiment, the method of the invention comprises the steps a), b), d) and e).

Functionalized (Cold-Gellable) Recombinant β-Lactoglobulin (rBLG)

The method of the invention as defined herein affords functionalized cold-gellable rBLG. Then, another object of the invention is the cold-gellable rBLG obtained according to the invention.

The cold-gellable rBLG is found in the form of aggregates. Cold-gellable rBLG aggregates have size preferably ranging from nanometer (nm) to micrometer (μm) scale. It has been found that the size of the aggregate impacts the gelling properties, the kinetics of gelling as well as strength and intrinsic properties of the gel. When the size of the aggregates is too high, the aggregates are not soluble.

Preferably, cold-gellable rBLG aggregates have a size ranging from 20 to 500 nm. Indeed, the size of the aggregate impacts the gelling properties, the kinetics of gelling as well as strength and intrinsic properties of the gel. When the size of the aggregates is too high, the aggregates are not soluble. Preferably, aggregates of the cold-gellable rBLG have a particle size ranging from 20 to 450 nm, preferably from 20 to 400 nm, preferably from 50 to 350 nm, preferably from 50 to 300 nm, preferably from 50 to 250 nm, preferably from 50 to 225 nm, preferably from 50 to 200 nm, preferably from 50 to 175 nm, preferably from 50 to 150 nm or preferably from 50 to 125 nm.

Aqueous Solution of Functionalized (Cold-Gellable) Recombinant β-Lactoglobulin (rBLG)

Another object of the present invention is an aqueous solution comprising the functionalized cold-gellable rBLG and preferably one or more polysaccharides. In a particular embodiment, the aqueous solution of functionalized cold-gellable rBLG comprises from 3 to 15% w/w of cold-gellable rBLG, preferably from 3 to 9% w/w of cold-gellable rBLG, from 0.1 to 5% w/w of polysaccharide and water.

The aqueous solution of cold-gellable rBLG according to the invention has a similar composition to the one of the rBLG aqueous solution as defined above. Consequently, the cold-gellable rBLG content, the polysaccharide content, the sugar content and the lipid content in the cold-gellable rBLG solution are the same as for the rBLG aqueous solution. It is understood that, due to the treatments applied to the rBLG aqueous solution, the percentages defining the content of cold-gellable rBLG, polysaccharides, sugars and lipids are modified according to the concentration of the cold-gellable rBLG aqueous solution. The components, contents and definitions described above for the aqueous solution of rBLG apply mutatis mutandis for the aqueous solution of cold-gellable rBLG.

However, the ratios between the different components in the cold-gellable rBLG aqueous solution are not altered, and thus are the same as for the rBLG aqueous solution.

In one embodiment, the polysaccharide/cold-gellable rBLG ratio is lower than or equal to 1/2, and preferably equal to or lower than 1/3.

According to the invention, the aqueous solution comprising cold-gellable rBLG and polysaccharides has a polysaccharide/cold-gellable rBLG ratio ranging from 1/30 to 1/2, preferably from 1/30 to 1/3, more preferably from 1/25 to 1/3, even more preferably from 1/20 to 1/3, and still better from 1/10 to 1/3, and even still better from 1/15 to ⅓ or preferably between 1/15 and 1/5.

Advantageously, the aqueous solution according to the invention comprising cold-gellable rBLG and polysaccharide has a polysaccharide/cold-gellable rBLG ratio of around 1/6, around 1/5 or around 1/4.

According to the invention, when present, the quantity of additional sugars can be defined by a sugars/cold-gellable rBLG ratio. Preferably, the sugars/cold-gellable rBLG ratio in the aqueous solution is lower than 1/20, preferably lower than 1/50, more preferably lower than 1/75, and even ore preferably lower than 1/100. Advantageously, the sugars/cold-gellable rBLG ratio is lower than 1/110, lower than 1/120, or even lower than 1/130. In a preferred embodiment, the sugars/cold-gellable rBLG ratio is comprised between 1/120 to 1/130.

Dry Functionalized (Cold-Gellable) Recombinant β-Lactoglobulin (rBLG)

The present invention also relates to dry functionalized cold-gellable rBLG obtained according to the method as defined above. Particularly, the invention relates to a dry composition comprising cold-gellable rBLG and at least one polysaccharide as defined above. The composition of the invention preferably comprises from 45 to 95% w/w of cold-gellable rBLG in relation to the total weight of the composition.

In one embodiment, the dry composition according to the invention comprises more than 45% w/w, more than 50% w/w, more than 55% w/w, more than 60% w/w, more than 65% w/w, or even more than 70% w/w of cold-gellable rBLG in weight in relation to the total weight of the composition.

In one embodiment, the dry cold-gellable rBLG composition comprises a cold-gellable rBLG content comprised between 45 and 95% w/w, preferably between 50 and 95% w/w, preferably between 55 and 95% w/w, more preferably between 60 and 95% w/w, even more preferably between 65 and 95% w/w, and still better between 70 and 95% w/w of rBLG, in weight in relation to the total weight of the dry composition. Preferably, the dry composition comprises from 70 to 92% w/w of rBLG, preferably from 72 to 91% w/w, more preferably between 75 to 90% w/w, more preferably between 77 and 90% w/w, even more preferably between 80 and 90% w/w of cold-gellable rBLG, in weight in relation to the total weight of the dry composition. In another embodiment the dry cold-gellable rBLG composition comprises a rBLG content comprised between 82 and 90% w/w of cold-gellable rBLG, preferably between 85 and 90% w/w of cold-gellable rBLG in relation to the total weight of the dry cold-gellable composition.

According to the invention, the dry cold-gellable rBLG composition further comprises polysaccharides as defined above. Preferably, the dry cold-gellable rBLG composition comprises at least one polysaccharide, said polysaccharide being preferably of fungal origin, and in particular isolated from filamentous fungi selected from the group of species of Aspergillus and Trichoderma.

When present, and according to the invention, the polysaccharide content in the dry cold-gellable rBLG composition ranges from 0 to 50% w/w in relation to the total weight of the dry composition.

In one embodiment, the polysaccharide content in the dry cold-gellable rBLG composition is lower than 40% w/w, and preferably lower than 30% w/w in relation to the total weight of the dry composition.

In one embodiment, the polysaccharide content ranges from 0 to 30% w/w, from 2 to 30% w/w, or from 5 to 30% w/w, or from 8 to 30% w/w or from 8 to 25% w/w, preferably from 9 to 22% w/w, and more preferably from 10 to 20% w/w in relation to the total weight of the dry composition. Advantageously, the polysaccharide content in the dry cold-gellable rBLG composition is around 10% w/w, 15% w/w or 20% w/w in relation to the total weight of the dry composition.

In an alternative way, when present, the content of polysaccharide in the dry cold-gellable rBLG composition can be defined as a polysaccharide/cold-gellable rBLG ratio.

In some embodiments, the dry cold-gellable rBLG composition comprises cold-gellable rBLG and polysaccharides with a polysaccharide/cold-gellable rBLG ratio ranging from 1/30 to 1/2, preferably from 1/30 to 1/3, preferably from 1/25 to 1/3, preferably from 1/20 to 1/3, or preferably from 1/10 to 1/3, or preferably from 1/15 to 1/3, or preferably between 1/15 and

Advantageously, dry cold-gellable rBLG composition has a polysaccharide/cold-gellable rBLG ratio of around 1/6, around 1/5 or around 1/4.

The dry cold-gellable rBLG composition according to the invention can further comprises sugars as defined above. When present, the dry cold-gellable rBLG composition comprises sugars preferably with a concentration lower than 1% w/w, or even lower than 0.5% w/w, the percentage being expressed in weight in relation to the total weight of the dry composition. More preferably, the dry cold-gellable rBLG composition does not comprise additional sugars, except from the residual sugars from the isolation of rBLG from the culture of the genetically modified organism producing the rBLG.

When present, the quantity of additional sugars can also be defined by a sugars/rBLG ratio. Preferably, the sugars/cold-gellable rBLG ratio in the dry cold-gellable composition is lower than 1/20, preferably lower than 1/50, more preferably lower than 1/75, and even more preferably lower than 1/100. Advantageously, the sugars/cold-gellable rBLG ratio is lower than 1/110, lower than 1/120, or even lower than 1/130. In a preferred embodiment, the sugars/cold-gellable rBLG ratio is comprised between 1/120 to 1/130.

Some lipids can also be found in the dry cold-gellable rBLG composition according to the invention, lipids being those defined above. When present, the lipid concentration in the dry cold-gellable rBLG composition is lower than 1% w/w, or even lower than 0.5% w/w, the percentage being expressed in weight in relation to the total weight of the dry composition. More preferably, the dry cold-gellable rBLG composition does not comprise additional lipids.

Preferably, the dry cold-gellable rBLG is in the form of aggregates, and aggregates have a particle size ranging from 20 to 500 nm. Preferably, aggregates of the dry cold-gellable rBLG have a particle size ranging from 20 to 450 nm, preferably from 20 to 400 nm, preferably from 50 to 350 nm, preferably from 50 to 300 nm, preferably from 50 to 250 nm, preferably from 50 to 225 nm, preferably from 50 to 200 nm, preferably from 50 to 175 nm, preferably from 50 to 150 nm or preferably from 50 to 125 nm.

Use of Functionalized (Cold-Gellable) Recombinant β-Lactoglobulin (rBLG)

The invention concerns the use of cold-gellable rBLG according to the invention, either as a dry cold-gellable rBLG composition or as a cold-gellable rBLG aqueous solution as defined above for making a gel. Indeed, the cold-gellable rBLG has emulsifying and gelling properties allowing its use in various industries and in particular in the food industry.

Production of gel from cold-gellable rBLG according to the invention is performed by a) dissolving cold-gellable rBLG in water to form an aqueous solution of functionalized rBLG, and b) gelling of the cold-gellable rBLG in conditions of reduced electrostatic repulsions between cold-gellable rBLG aggregates. These conditions can be obtained for example, by adding to cold-gellable rBLG solution, salts such as calcium (salt-induced gelation) or by lowering the pH towards the isoelectric point (acid-induced gelation).

Dissolution of the dry cold-gellable rBLG is carried out at a temperature ranging from 1 to 60° C., and preferably at a temperature lower than 45° C., more preferably at a temperature equal or lower than 30° C. Advantageously, dissolution of dry cold-gellable rBLG composition according to the invention is carried out at a temperature ranging from 10 to 30° C., preferably from 15 to 30° C., and more preferably from 15 to 25° C.

In some embodiments, dry cold-gellable rBLG can be part of a mix of food ingredients such as starch, texturizers like pectin and carrageenan, vegetable oil, sugars, flavors or even milk, and/or water, optionally the mix being pasteurized, optionally homogenized or submitted to any other processing steps of food transformation.

Following the dissolution, and/or the mixing, and/or the processing of the mix, the solution is acidified to pH between 4 and 6. Preferably, gelation occurs at a pH between 4.5 and 6, and advantageously at a pH between 4.5 and 5.5, and preferably around 4.60 or around 5.2.

In some preferred embodiments, the acidification of the solution of cold-gellable rBLG or of the mix of ingredients comprising cold-gellable rBLG is obtained by using glucono-delta-lactone (GDL) in an appropriate amount, and can take several hours, at a temperature between 1° C. and 60° C. In some embodiments, gelation is carried out for few minutes or few hours. Thus, the gelling step is preferably carried out from 1 minute to 72 hours, from 5 minutes to 48 hours, or preferably from 5 minutes to 24 hours or from 5 minutes to 12 hours. In some embodiments, the gelling step is carried out from 10 minutes to 1 hour, preferably from 10 to 30 minutes. Advantageously, gelling is carried out for 5 minutes to 1 hour, preferably from 10 to 30 minutes. The temperature of the gelling step advantageously ranges from 1 to 60° C., preferably from 1 to 50° C., and more preferably from 5 to 30° C.

In other preferred embodiments the acidification of the solution of cold-gellable rBLG or of the mix of ingredients comprising cold-gellable rBLG is obtained by adding culture microorganisms such as lactic acid bacteria. The acidification is then carried out for several hours, preferably from 1 to 20 hours and at a temperature between 5° C. and 55° C.

Yet, in other preferred embodiments the acidification of the solution of cold-gellable rBLG or of the mix of ingredients comprising cold-gellable rBLG is obtained by adding an acid or a food grade acidifier additive such as citric acid or lemon juice concentrate. The solution is then left at a temperature comprised between 1 and 60° C. for several minutes or hours, and in particular from 1 minutes to 10 hours, to form the rBLG gel.

Still in other preferred embodiments, and following the dissolution of dry cold-gellable rBLG, and/or the mixing of dry cold-gellable rBLG with other ingredients and/or water, and/or the processing of the mix, the solution comprising cold-gellable rBLG leads to the formation of the rBLG gels after addition of an appropriate amount of salts, as for example calcium, the salt being preferentially added gradually into the solution. Gelling occurs at a temperature comprised between 1 and 60° C. for a period of time of 1 minute to 10 hours.

Also, in other preferred embodiments, following the dissolution of dry cold-gellable rBLG, and/or the mixing of dry cold-gellable rBLG with other food ingredients and water, the solution or the mix containing rBLG can be processed into food products without the need of acidification. Such food products are for example ice cream, cream dessert, processed cheese, hard cheese, etc.

The invention further concerns the use of cold-gellable rBLG according to the invention, in a dry form or as an aqueous solution for making non-animal dairy products or animal dairy product. The invention can particularly be used in the manufacture of yogurts, cream cheese, fresh cheese and ice creams.

Dairy Products Comprising Functionalized (Cold-Gellable) Recombinant β-Lactoglobulin (rBLG)

Dairy products comprising cold-gellable rBLG according to the invention have advantageously the texture and sensation of “classic” dairy product, and in some embodiments, they are free from milk produced by an animal. These products may also be termed non-animal dairy analogs or non-animal dairy products (or dairy-like products).

In other embodiments, dairy products comprising cold-gellable rBLG according to the invention, can comprise animal-derived component. These products are termed dairy products or animal dairy products.

Animal or non-animal dairy products may include one or more additional components chosen from proteins, texture agents, lipids, flavor compounds, sweetening agents, color balancing agents, ashes, vitamins, or any combinations thereof. Embodiments include animal and non-animal dairy products comprising animal derived components (i.e. animal dairy products), non-animal derived components (i.e. non-animal dairy products), or a combination thereof (animal dairy products).

The term “texture agent”, as used herein, refers to any substance added to food products to modify their physical properties, particularly their texture and mouthfeel, without significantly affecting their flavor or nutritional value. Texture agents are widely used in the food industry to achieve desired textures, stabilize formulations, thicken liquids, and form gels in a variety of food products, contributing to the overall sensory experience of the food. It can be derived from numerous sources, such as for example plants, animals, and seaweeds.

Animal or non-animal dairy products of the present invention can also further include one or more texture agents. Examples of texture agents are maltodextrin, native starches, modified starches, cellulose derivatives (e.g., microcrystalline cellulose), carrageenans, xanthan gum, guar gum, locust bean gum, acacia gum, agar-agar, gelatin, pectin, alginate, or plant proteins (e.g., soy proteins, pea proteins) and mixtures thereof.

The term “lipids” means one or more molecules (e.g., biomolecules) that include a fatty acyl group (e.g., saturated or unsaturated acyl chains). For example, the lipids include oils, phospholipids, free fatty acids, phospholipids, monoglycerides, diglycerides, and triglycerides and mixtures thereof. Non-limiting examples of lipids are described herein.

Lipids suitable in the animal or non-animal dairy products of the present invention can be selected from the group consisting of sunflower oil, coconut oil, tributyrin, mono- and di-glycerides, free fatty acids, phospholipids and mixtures thereof. In some embodiments of any of the compositions described herein, the free fatty acids are selected from the group of: butyric acid, caproic acid, caprylic acid, and capric acid and mixtures thereof. In some embodiments of any of the compositions described herein, the phospholipids are selected from soy lecithin phospholipids, sunflower lecithin phospholipids, cotton lecithin phospholipids, or rapeseed lecithin phospholipids and mixtures thereof. In some embodiments of any of the compositions described herein, the monoglycerides and diglycerides are plant-derived monoglycerides and diglycerides, or are bacteria-derived monoglycerides and diglycerides.

Lipids can also be plant-derived lipids, that is to say a lipid obtained from and/or produced by a plant (e.g. monocot or dicot).

The term “flavors”, as used herein, refers to the taste and/or the aroma of a food or a drink. According to the invention, flavor compounds are preferably selected from the group consisting of: 8-decalactone, ethyl butyrate, 2-furyl methyl ketone, 2,3-pentanedione, y-undecalactone, and 8-undecalactone and mixtures thereof.

“Sweetening agent” refers to a saccharide (e.g., a monosaccharide, a disaccharide, or a polysaccharide) or an artificial sweetener (e.g., a small molecule artificial sweetener or a protein artificial sweetener) that, when added to a composition, makes the composition taste sweet when ingested by a mammal, such as a human. Non-limiting examples of sweetening agents are described herein.

Examples of sweetening agents suitable for animal or non-animal dairy products according to the invention are saccharides selected from the group consisting of: glucose, mannose, maltose, fructose, galactose, lactose, sucrose, monatin, and tagatose and mixtures thereof. In some embodiments sweetening agent is an artificial sweetener, and preferably selected from the group consisting of: stevia, aspartame, cyclamate, saccharin, sucralose, mogrosides, brazzein, curculin, erythritol, glycyrrhizin, inulin, isomalt, lacititol, mabinlin, malititol, mannitol, miraculin, monatin, monelin, osladin, pentadin, sorbitol, thaumatin, xylitol, acesulfame potassium, advantame, alitame, aspartame-acesulfame, sodium cyclamate, dulcin, glucin, neohesperidin dihyrdochalcone, neotame, and P-4000, and mixture thereof.

The term “color balancing agent” or “coloring agent” refers to an agent added to a composition to modulate the color of the composition, e.g., to make the color of the composition appear more similar to a mammal-produced milk. Non-limiting examples of color balancing agents or coloring agents include β-carotene and annatto. A color balancing agent or a coloring agent can be produced by or obtained from a plant.

The term “ash” is an art-known term and represents one or more ions, elements, minerals, and/or compounds that can be found in a mammal-produced milk. Non-limiting ions, elements, minerals, and compounds that are found in a mammal-produced milk, are for instance calcium, phosphorus, potassium, sodium, citrate, and chloride.

In some embodiments, animal or non-animal dairy products of the present invention may further comprise one or more ashes. The ash is preferably chosen from minerals. In some embodiments of these dairy products, the minerals are preferably chosen from sodium, potassium, calcium, magnesium, phosphorus, iron, copper, zinc, chloride, manganese, selenium, iodine, retinol, carotene, vitamins, vitamin D, vitamin E, vitamin B12, thiamin and riboflavin and mixtures thereof. In some embodiments of these animal or non-animal dairy products, the ash is preferably chosen among anions. In some embodiments of these animal or non-animal dairy products, the ashes are chosen among phosphate, citrate, sulfate, carbonate, and chloride and mixtures thereof.

The term “vitamin” refers to organic molecules (or a set of closely related molecules called vitamers) that are essential to an organism in small quantities for proper metabolic function. According to the invention, vitamins that can be used in the dairy products are preferably chosen from lipid soluble vitamins, water soluble vitamins, thiamin [vitamin B1], riboflavin [vitamin B2], niacin 0 [vitamin B3], pantothenic acid [vitamin B5], vitamin B6 [pyridoxine], vitamin B12 [cobalamin], vitamin C, folate, vitamins A, vitamin D, vitamin E, vitamin K and mixtures thereof.

In some embodiments, animal or non-animal dairy products according to the invention may further comprise fat. Fat includes triglycerides, and/or high-oleic oil. In some embodiments of these animal or non-animal dairy products, the high-oleic oil is chosen from mono unsaturates, oleic, linoleic, linolenic and saturates and mixtures thereof. In some embodiments of these animal or non-animal dairy products, the fats comprise short chain fatty acids. In some embodiments of these animal or non-animal dairy products, the short chain fatty acids are selected among butanoic, hexanoic, octanoic, and decanoic acids and mixtures thereof. In some embodiments of these animal or non-animal dairy products, one or more of the fats comprised trans-esterified fatty acids. In some embodiments of these animal or non-animal dairy products, one or more of the fats are isolated from plants. In some embodiments of these animal or non-animal dairy products, the plant is selected from one or more of the following: sunflower, corn, olive, soy, peanut, walnut, almond, sesame, cottonseed, canola, safflower, flax seed, palm, palm kernel, palm fruit, coconut, babassu, shea butter, mango butter, cocoa butter, wheat germ and rice bran oil.

In some embodiments, animal or non-animal dairy products can further comprise sugars, said sugars comprising galactose, sucrose, glucose, fructose and maltose and mixtures thereof. In some embodiments of these animal or non-animal dairy products, the dairy substitute food product is essentially free of lactose.

According to the invention, animal or non-animal dairy products comprising cold-gellable rBLG have preferably one or more characteristics of a classic dairy food product selected from the group consisting of: taste, aroma, appearance, handling, mouthfeel, density, structure, texture, elasticity, springiness, coagulation, binding, leavening, aeration, foaming, creaminess and emulsification.

Preferably, animal or non-animal dairy products according to the invention, i.e. comprising cold-gellable rBLG, have improved or modified properties as compared to a classic dairy product. In some embodiments, the properties may be for example, but without limitation, the viscosity, the foaming effect, the buffering effect, storage time, opacity, smell, etc.

In some embodiments, the cold-gellable rBLG can be processed into high protein food products. Such high protein food products are for example high protein yogurts, high protein UHT (ultra heat treatment) drinks, high protein fruit preparations, high protein cream cheeses, high protein snacks, high proteins bites, high proteins cereal bars, high protein ready to drink milk, high protein milk beverages, or high protein beverages.

In some embodiments, the non-animal dairy product is a vegan dairy product, and then can further comprise one or more of (a) a plant-derived oil; (b) a plant-derived starch: (c) a sugar; and (d) a salt. In some embodiments, the dairy product further comprises a flavoring selected from cheddar flavor, parmesan flavor or mozzarella flavoring.

In other embodiments, the animal or non-animal dairy product can comprise respectively one or more of animal-derived or non-animal derived beta lactoglobulin, serum albumin, lactoferrin, and transferrin. Preferably, in some embodiments of any of the compositions described herein, the beta-lactoglobulin is a cow, human, sheep, goat, buffalo, camel, horse, donkey, lemur, panda, guinea pig, squirrel, bear, macaque, gorilla, chimpanzee, mountain goat, monkey, ape, cat, dog, wallaby, rat, mouse, elephant, opossum, rabbit, whale, baboons, gibbons, orangutan, mandrill, pig, wolf, fox, lion, tiger, echidna, or woolly mammoth beta-lactoglobulin; the serum albumin is a cow, human, sheep, goat, buffalo, camel, horse, donkey, lemur, panda, guinea pig, squirrel, bear, macaque, gorilla, chimpanzee, mountain goat, monkey, ape, cat, dog, wallaby, rat, mouse, elephant, opossum, rabbit, whale, baboons, gibbons, orangutan, mandrill, pig, wolf, fox, lion, tiger, echidna, or woolly mammoth serum albumin; the lactoferrin is a cow, human, sheep, goat, buffalo, camel, horse, donkey, lemur, panda, guinea pig, squirrel, bear, macaque, gorilla, chimpanzee, mountain goat, monkey, ape, cat, dog, wallaby, rat, mouse, elephant, opossum, rabbit, whale, baboons, gibbons, orangutan, mandrill, pig, wolf, fox, lion, tiger, echidna, or woolly mammoth lactoferrin; and/or the transferrin is a cow, human, sheep, goat, buffalo, camel, horse, donkey, lemur, panda, guinea pig, squirrel, bear, macaque, gorilla, chimpanzee, mountain goat, monkey, ape, cat, dog, wallaby, rat, mouse, elephant, opossum, rabbit, whale, baboons, gibbons, orangutan, mandrill, pig, wolf, fox, lion, tiger, echidna, or woolly mammoth transferrin protein.

In some embodiments, animal or non-animal dairy products comprising cold-gellable rBLG according to the invention, further includes respectively one or more of: animal-derived or non-animal-derived kappa casein, beta casein, alpha SI casein, and alpha S2 casein. The kappa/beta/alpha S1/alpha S2 casein can be a cow, human, sheep, goat, buffalo, camel, horse, donkey, lemur, panda, guinea pig, squirrel, bear, macaque, gorilla, chimpanzee, mountain goat, monkey, ape, cat, dog, wallaby, rat, mouse, elephant, opossum, rabbit, whale, baboons, gibbons, orangutan, mandrill, pig, wolf, fox, lion, tiger, echidna, or woolly mammoth kappa/beta/alpha S1/alpha S2 casein protein.

Suitable non-animal protein can be a native or recombinant non-animal protein, or hydrolyzed native or recombinant non-animal protein, or combinations thereof. Non-animal components can also derive from non-animal sources including naturally occurring or modified plants, algae, fungi, or microbes.

Examples of suitable plants include but are not limited to spermatophytes (spermatophyta), acrogymnospermae, angiosperms (magnoliophyta), ginkgoidae, pinidac, mesangiospermac, cycads, Ginkgo, conifers, gnetophytes, Ginkgo biloba, cypress, junipers, thuja, cedarwood, pines, angelica, caraway, coriander, cumin, fennel, parsley, dill, dandelion, helichrysum, marigold, mugwort, safflower, camomile, lettuce, wormwood, calendula, citronella, sages, thyme, chia seed, mustard, olive, coffee, capsicum, eggplant, paprika, cranberry, kiwi, vegetable plants (e.g., carrot, celery), tagetes, tansy, tarragon, sunflower, wintergreen, basil, hyssop, lavender, lemon verbena, marjoram, melissa, patchouli, pennyroyal, peppermint, rosemary, sesame, spearmint, primroses, samara, pepper, pimento, potato, sweet potato, tomato, blueberry, nightshades, petunia, morning glory, lilac, jasmin, honeysuckle, snapdragon, psyllium, wormseed, buckwheat, amaranth, chard, quinoa, spinach, rhubarb, jojoba, cypselca, chlorella, manila, hazelnut, canola, kale, bok choy, rutabaga, frankincense, myrrh, elemi, hemp, pumpkin, squash, curcurbit, manioc, dalbergia, legume plants (e.g., alfalfa, lentils, beans, clovers, peas, fava coceira, frijole bola roja, frijole negro, lespedeza, licorice, lupin, mesquite, carob, soybean, peanut, tamarind, wisteria, cassia, chickpea, garbanzo, fenugreek, green pea, yellow pea, snow pea, lima bean, fava bean), geranium, flax, pomegranate, cotton, okra, neem, fig, mulberry, clove, eucalyptus, tea tree, niaouli, fruiting plants (e.g., apple, apricot, peach, plum, pear, nectarine), strawberry, blackberry, raspberry, cherry, prune, rose, tangerine, citrus (e.g., grapefruit, lemon, lime, orange, bitter orange, mandarin), mango, citrus bergamot, buchu, grape, broccoli, brussels, sprout, camelina, cauliflower, rape, rapeseed (canola), turnip, cabbage, cucumber, watermelon, honeydew melon, zucchini, birch, walnut, cassava, baobab, allspice, almond, breadfruit, sandalwood, macadamia, taro, tuberose, aloe vera, garlic, onion, shallot, vanilla, yucca, vetiver, galangal, barley, corn, Curcuma aromatica, ginger, lemon grass, oat, palm, pineapple, rice, rye, sorghum, triticale, turmeric, yam, bamboo, barley, cajuput, canna, cardamom, maize, oat, wheat, cinnamon, sassafras, Lindera benzoin, bay laurel, avocado, ylang-ylang, mace, nutmeg, moringa, horsetail, oregano, cilantro, chervil, chive, aggregate fruits, grain plants, herbal plants, leafy vegetables, non-grain legume plants, nut plants, succulent plants, land plants, water plants, delbergia, millets, drupes, schizocarps, flowering plants, non-flowering plants, cultured plants, wild plants, trees, shrubs, flowers, grasses, herbaccous plants, brushes, lianas, cacti, green algae, tropical plants, subtropical plants, temperate plants, and derivatives and crosses thereof.

Examples of suitable algae include but are not limited to green algae (e.g., Chlorella), brown algae (e.g., Alaria marginata, Analipus japonicus, Ascophyllum nodosum, Ecklonia sp, Eisenia bicyclis, Hizikia fusiforme, Kjellmaniella gyrata, Laminaria angustata, Laminaria longirruris, Laminaria Longissima, Laminaria ochotensis, Laminaria claustonia, Laminaria saccharina, Laminaria digitata, Laminaria japonica, Macrocystis pyrifera, Petalonia fascia, Scytosiphon lome), red algae (e.g., Gigartinaceae, Soliericeae, Chondrus crispus, Chondrus ocellatus, Eucheuma cottonii, Eucheuma spinosum, Furcellaria fastigiata, Gracilaria bursa-pastoris, Gracilaria lichenoides, Gloiopeltis furcata, Gigartina acicularis, Gigartina bursa-pastoris, Gigartina pistillata, Gigartina radula, Gigartina skottsbergii, Gigartina stellata, Palmaria palmata, Porphyra columbina, Porphyra crispata, Porhyra deutata, Porhyra perforata, Porhyra suborbiculata, Porphyra tenera, Porphyridium cruentum, Porphyridium purpureum, Porphyridium acrugineum, Rhodella maculate, Rhodella reticulata, Rhodella violacea, Rhodophyceae, Rhodymenia palmata), and derivatives and crosses thereof.

Examples of suitable fungi include but are not limited to Aspergillus sp., Aspergillus nidulans, Aspergillus niger, Aspergillus niger var. awamori, Aspergillus oryzae, Candida albicans, Candida etchellsii, Candida guilliermondii, Candida humilis, Candida lipolytica, Candida pseudotropicalis, Candida utilis, Candida versatilis, Chrysosporium lucknowense, Debaryomyces hansenii, Endothia parasitica, Eremothecium ashbyii, Fusarium sp., Fusarium gramincum, Fusarium moniliforme, Fusarium venenatum, Hansenula polymorpha, Kluyveromyces sp., Kluyveromyces lactis, Kluyveromyces marxianus, Kluyveromyces marxianus var. lactis, Kluyveromyces thermotolerans, Morteirella vinaceae var. raffinoseutilizer, Mucor michei, Mucor michei var. Cooney et Emerson, Mucor pusillus Lindt Myceliophthora thermophile, Neurospora crassa, Penicillium roquefortii, Physcomitrella patens, Pichia sp., Pichia pastoris, Pichia finlandica, Pichia trehalophila, Pichia koclamac, Pichia membranacfaciens, Pichia minuta (Ogataca minuta, Pichia lindneri), Pichia opuntiac, Pichia thermotolerans, Pichia salictaria, Pichia guercuum, Pichia pijperi, Pichia stiptis, Pichia methanolica, Rhizopus niveus, Rhodotorula sp., Saccharomyces sp., Saccharomyces bayanus, Saccharomyces beticus, Saccharomyces cerevisiae, Saccharomyces chevalieri, Saccharomyces diastaticus, Saccharomyces ellipsoideus, Saccharomyces exiguus, Saccharomyces florentinus, Saccharomyces fragilis, Saccharomyces pastorianus, Saccharomyces pombe, Saccharomyces sake, Saccharomyces uvarum, Sporidiobolus johnsonii, Sporidiobolus salmonicolor, Sporobolomyces roseus, Trichoderma, Trichoderma reesei, Xanthophyllomyces dendrorhous, Yarrowia lipolytica, Zygosaccharomyces rouxii, and derivatives and crosses thereof.

Examples of suitable microbes include but are not limited to firmicutes, cyanobacteria (blue-green algae), oscillatoriophcideae, bacillales, lactobacillos, oscillatoriales, bacillaceae, lactobacilloac, Acetobacter suboxydans, Acetobacter xylinum, Actinoplane missouriensis, Arthrospira platensis, Arthrospira maxima, Bacillus cereus, Bacillus coagulans, Bacillus subtilus, Bacillus cerus, Bacillus licheniformis, Bacillus stearothermophilus, Bacillus subtilis, Escherichia coli, Lactobacillus acidophilus, Lactobacillus bulgaricus, Lactococcus lactis, Lactococcus lactis Lancefield Group N, Lactobacillus reuteri, Leuconostoc citrovorum, Leuconostoc dextranicum, Leuconostoc mesenteroides strain NRRL B-512 (F), Micrococcus lysodeikticus, Spirulina, Streptococcus cremoris, Streptococcus lactis, Streptococcus lactis subspecies diacetylactis, Streptococcus thermophilus, Streptomyces chattanoogensis, Streptomyces griseus, Streptomyces natalensis, Streptomyces olivaceus, Streptomyces olivochromogenes, Streptomyces rubiginosus, Tetrahymena thermophile, Tetrahymena hegewischi, Tetrahymena hyperangularis, Tetrahymena malaccensis, Tetrahymena pigmentosa, Tetrahymena pyriformis, and Tetrahymena vorax, and Xanthomonas campestris, and derivatives and crosses thereof.

### BRIEF DESCRIPTION OF THE DRAWINGS

FIG. 1: HPLC analysis of a rBLG sample compared to animal BLG (WPI, whey protein isolated from milk).

FIG. 2: TEM pictures at different magnifications showing soluble aggregates of cold-gellable recombinant BLG produced according to conditions J listed in table 2.

FIG. 3: texturometer profile during analysis of cold-gellable rBLG protein acid gel: hardness (g), consistency (g.s) and stickiness (g) were measured. Cold-gellable rBLG protein were produced following conditions J (Table 2).

FIG. 4: gel filtration chromatogram obtained for commercial native bovine BLG (A), recombinant BLG (B) and heat induced cold-gellable rBLG (C) according to the present invention.

FIG. 5: size distribution by volume of recombinant BLG (comparative).

FIG. 6: size distribution by volume of cold-gellable recombinant BLG (invention).

### EXAMPLES

The present invention is further illustrated in a non-limitative manner by the following examples.

rBLG used in the examples is rBLG obtained by precision fermentation and has the following composition (table 1).

TABLE 1
rBLG composition. “Total carbs” corresponds
to polysaccharides.

| Analysis | rBLG |
|---|---|
| Protein “as is” | 82.7% |
| bLG content as % total protein | 100% |
| Moisture | 5.3% |
| Ash | 1.64% |
| Total Carbs | 10.4% |
| Fat | <0.6% |

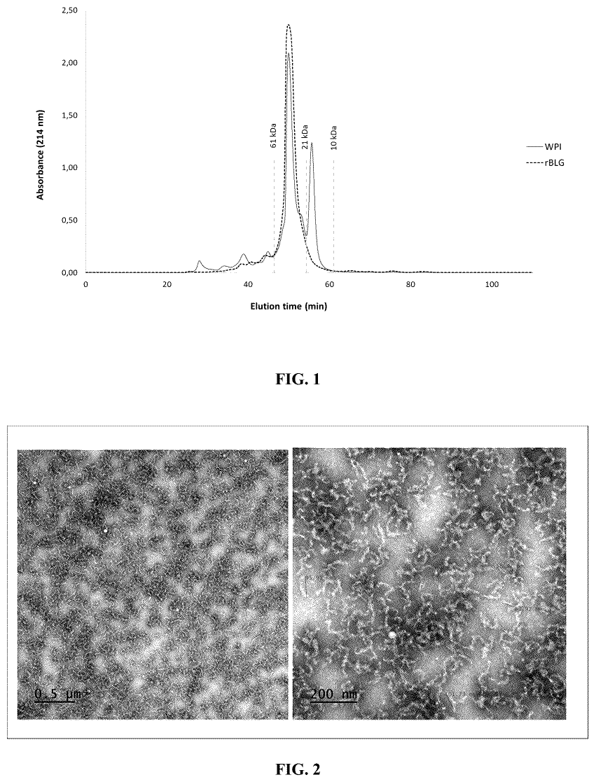

Purity analysis was performed by HPLC and compared to WPI (bovine whey protein isolate) used as a reference. The chromatogram of the analysis is given in FIG. 1.

The chromatogram of the reference (WPI) shows two peaks: one between 10 and 21 kDa corresponding to alactalbumin and one between 20 and 60 kDa corresponding to dimeric β-lactoglobulin. The sample of native rBLG shows one main peak, corresponding to dimeric β-lactoglobulin. The rBLG sample can be considered as pure β-lactoglobulin.

### Example 1: Production of Cold-Gellable Soluble Aggregates from rBLG and WPI

### General Procedure

WPI (Whey Protein Isolate) (Reference PRONATIV 95LL, Lactalis, France) contains 91% w/w of protein and was produced by filtration of bovine milk.

rBLG and WPI protein powders were rehydrated in demineralized water at room temperature to produce 5% and 7% w/w protein solutions. pH of the solutions was 6.7 and was kept unchanged. Production of cold-gellable soluble aggregates were then performed following the conditions shown on table 2 (conditions A to L). The heating step was performed under moderate agitation (150 rpm), at a temperature of 80° C., a holding time of 5, 10 or 15 min, from solutions of WPI or rBLG of 5% or 7% w/w protein concentrations. Finally, the heated protein solutions were rapidly cooled to 27° C.

TABLE 2
Conditions for the production of cold-gellable soluble
aggregates from WPI and rBLG.

| | | Protein | Heating | Holding |
|---|---|---|---|---|
| | Type of | concentration | temperature | time |
| Conditions | protein | (%) | (° C.) | (min) |
| A | WPI | 5 | 80 | 5 |
| B | WPI | 5 | 80 | 10 |
| C | WPI | 5 | 80 | 15 |
| D | WPI | 7 | 80 | 5 |
| E | WPI | 7 | 80 | 10 |
| F | WPI | 7 | 80 | 15 |
| G | rBLG | 5 | 80 | 5 |
| H | rBLG | 5 | 80 | 10 |
| I | rBLG | 5 | 80 | 15 |
| J | rBLG | 7 | 80 | 5 |
| K | rBLG | 7 | 80 | 10 |
| L | rBLG | 7 | 80 | 15 |

### Results

With WPI (bovine whey proteins), all the conditions tested (A to F, table 2) led to the formation of soluble protein aggregates, without flocculation or gelation of the solutions during the heating step, the cooling step and storage at room temperature, as assessed by visual observation.

Same results were obtained with rBLG. The conditions tested (G to L, table 2) led to the formation of soluble protein aggregates, without flocculation or gelation of the solutions during the heating step, the cooling step and storage at room temperature, as assessed by visual observation.

### Example 2: Microscopic Observations (TEM) of Cold-Gellable Soluble Aggregates Produced from rBLG

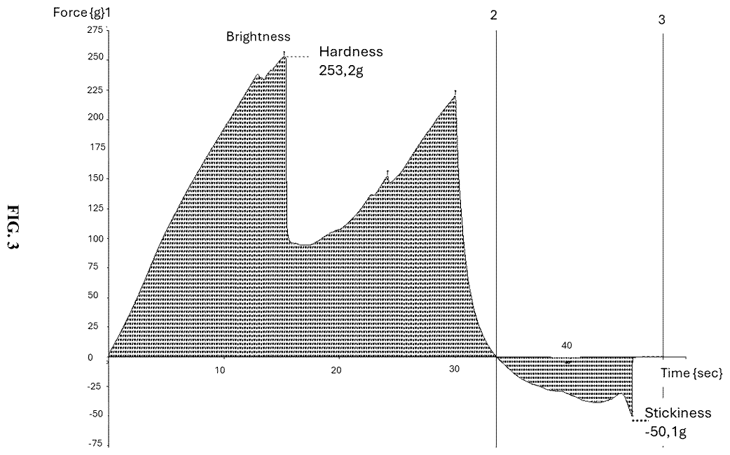

The solution of cold-gellable soluble aggregates produced from rBLG in conditions J shown in table 2 was characterized by Transmission Electron Microscopy (TEM) (FIG. 2). The sample preparation for TEM was the following: Hydrophilization of a 200 mesh copper grid covered with a formvar/carbon film; Deposition of the sample diluted ×10 on the surface of the grid; Absorption of surplus after 1 minute; Negative contrast with 2% sodium silicotungstate for 30 sec; Observation with TEM JEOL 1400 and acquisition of images with a Gatan RIO 16 camera.

FIG. 2 evidenced the presence of protein aggregates that have a shape of small curve strands and a size approximately between 20 and 200 nm.

### Example 3: Production of Gel from Cold-Gellable Protein

### General Procedure

Samples of solutions of cold-gellable proteins produced in the conditions listed in table 2 were submitted to the following procedure to evaluate their capacity to form a gel at acidic pH at a temperature close to room temperature (27° C.) (i.e. cold gelation):

All solutions were set at 5% w/w protein concentration, when necessary by dilution with demineralized water.

GDL (Glucono-Delta Lactone) (0,75% w/w) was added to the solutions of 5% w/w cold-gellable proteins which were then left for gelling, unstirred, in a steam room at 27° C., until pH 4.50 is reached, then stored at 5° C. during 24h. Gel properties were then measured with TAX t Plus texturometer (Stable Microsystems) with a cylinder probe P/5 (5 mm diameter). Measurements conditions were as follow: compression step up to 15 mm at 0.5 mm/s; then return of the probe up to the surface (15 mm; 1 mm/s). Hardness is considered as the maximum force (g) during compression. The area under the curve represents the consistency (g·sec) during compression (consistency), and the maximum negative peak during probe return to surface corresponds to the stickiness. An example of the such measurement on 5% w/w solution of cold gellable rBLG (produced in conditions J of table 2) after acidification, is reported in FIG. 3.

### Results

TABLE 3
Impact of the different conditions of production of
cold-gellable protein aggregates (A to L) on the
physical properties of acid gel strength (5% protein).

| | Holding | Hardness | Consistency of | Stickiness |
|---|---|---|---|---|
| Conditions | time | of acid gel | acid gel | of acid gel |
| (see table 2) | (min) | (g) | (g · sec) | (g) |
| A | 5 | 24.6 | 456.3 | 5.6 |
| B | 10 | 23.6 | 508.9 | 7.8 |
| C | 15 | 60.1 | 1044.5 | 16.3 |
| D | 5 | 30.9 | 555.5 | 8.6 |
| E | 10 | 45.4 | 808.6 | 13.5 |
| F | 15 | 47.9 | 898.2 | 9.1 |
| G | 5 | 24.1 | 530.9 | 5.4 |
| H | 10 | 80.3 | 1875.3 | 20.6 |
| I | 15 | 187.4 | 3927.6 | 48.7 |
| J | 5 | 212.3 | 4053.9 | 38 |
| K | 10 | 315.9 | 5719.8 | 42.4 |
| L | 15 | 253.2 | 4497.3 | 50.1 |

The protein solutions of cold-gellable aggregates of bovine WPI (5% w/) produced during heating step in all the conditions tested (A to F: 5 to 7% initial protein concentration, 5 to 15 min holding time at 80° C., pH at 6,7) have formed strong gel after acidification to pH 4.5 at 27° C. Hardness of acid gel varies as a function of the conditions from 23.6 g to 60.1 g and consistency vary from 456 to 1044 g·sec. Stickiness varies from 5.6 to 16.3 g.

The protein solutions of cold-gellable aggregates of rBLG (5% w/w), produced during heating step in all the conditions tested (G to L: 5% and 7% initial protein concentration, 5 to 15 min holding time at 80° C., pH at 6.7) have formed even stronger gel after acidification to pH 4.5 at 27° C. than cold-gellable aggregates of WPI produced in the same conditions. Hardness of acid gel varies as a function of holding time and initial protein concentration from 24.1 g to 315.9 g and consistency vary from 530.9 to 5719.8 g·sec. Stickiness varies from 5.4 to 50.1 g.

Strength of acid gels produced with cold-gellable rBLG can be much higher than the ones produced with cold-gellable bovine WPI, which demonstrates much higher cold gelling capacity.

The results show that it is possible to produce cold-gellable protein aggregates with using rBLG as new raw material, with much higher gelling capacity than with using animal WPI.

### Example 4: Size of Aggregate

### General Procedure

### Aggregates Identification and Conversion Rate

Commercial native bovine BLG from Sigma Aldrich (St Louis, USA), recombinant BLG (rBLG) and heat-induced cold-gellable rBLG (cBLG) as defined in table 2, condition I (example 3), were analyzed by Sephacryl® S-300 gel filtration chromatography (Cytiva) in order to obtain a conversion rate of rBLG into cold-gellable rBLG (cBLG) after heat treatment. All samples of 0.5% w/w solutions were centrifuged during 10 minutes at 14000 g and 450 mL of the supernatant were injected in the chromatogram (AKTA system). The heights of the peaks were used for a conversion rate estimation.

### Size Distribution

Dynamic Light Scanning (DLS) analysis was performed on a Nanosizer Malvern at 20° C. After centrifugation, 200 μL of the samples were transferred to UV cell. Two runs of 10 replicates after equilibration of the sample in the UV cell were performed. Processing of polydispersity data was done with DTS Nano software.

### Results

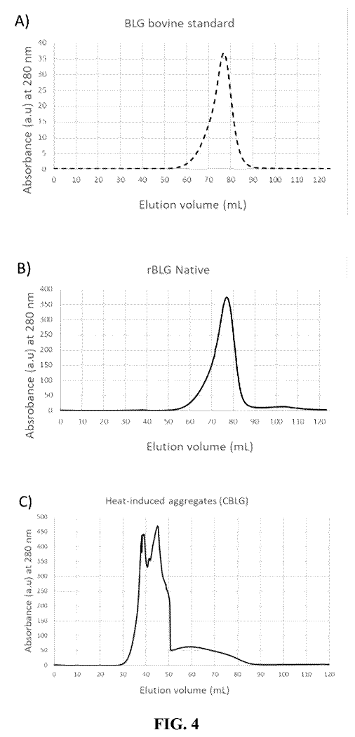

Commercial native BLG bovine (A) and recombinant BLG (B) have the same elution volume (at around 75 mL) (FIG. 4). After heat-treatment, around 90% of rBLG was converted in higher molecular weight aggregates identified in the chromatogram (C) and corresponding to heat induced cold-gellable rBLG (C) with an elution volume comprised between 30 and 50 mL.

An estimation of the conversion rate was obtained by considering the absorbance at around 75 mL in the heat induced cold-gellable rBLG solution (cBLG). The estimated conversion rate of rBLG into cBLG is calculated as the ratio in percent (%) between absorbance (in mAu) of 0.5% w/w cBLG solution and of 0.5% w/w rBLG solution at 75 mL elution volume. The result was 90.5%, showing an efficient method for the production of cold-gellable rBLG from rBLG. The values are presented in the Table 4.

TABLE 4
Absorbance measured at the elution peak for rBLG and cBLG
solution, and estimation of the conversion rate of rBLG into cBLG

| | Absorbance | Estimation of |
|---|---|---|
| | (mAu) at around | conversion rate of |
| Sample | 75 mL elution volume | rBLG to cBLG |
| rBLG solution | 326.4 | 90.5% |
| cBLG solution | 31 | |

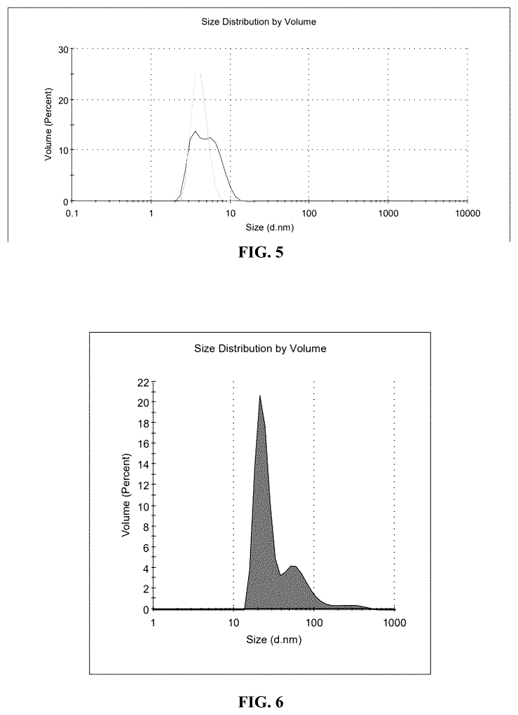

Dynamic Light Scanning (DLS) analysis indicated that rBLG solution comprises non aggregates particles with a size ranging between 3.7 and 6.6 nm (FIG. 5), corresponding to the size of globular protein in native state. The analysis was performed on 2 batches. DLS analysis of cold-gellable rBLG solution shows the presence of aggregates having a size ranging from 23 to 300 nm (average of 82 nm) (FIG. 6).

### Example 5: Gelling Capacities of rBLG According to the Invention Versus Native BLG

A) Gelling Capacity of rBLG According to the State of the Art

An aqueous rBLG solution (9.5% w/w) according to the invention was prepared and functionalized according to the process disclosed in Food Hydrocolloids 2005, pages 269-278.

Recombinant BLG (rBLG) in a powder form was added to deionised water to afford an aqueous solution with a concentration of 9.5% w/w of rBLG as defined in the present application. The solution was stirred for 1 h, and the pH was adjusted to pH 7 with HCl or NaOH before degassing the solution.

The obtained solution was functionalized by heating at 85° C. for 45 min in a water bath or in a MCR92 rheometer in CC10 coaxial geometry, before being cooled to 23° C. for 2 h.

Gelation of functionalized rBLG was observed during heating at 85° C. and a self-supported gel was obtained during heating step. Therefore, this functionalization step by heating did not lead to cold gellable rBLG aggregates in solution but led directly to thermal gelation. No further cold gelation step could be performed. In other words, no cold-gellable rBLG could be obtained from this process.

B) Gelling Properties of Commercial Native Bovine BLG and rBLG after Functionalization Measured by Texturometer

### General Procedure

Aqueous solutions of commercial native bovine BLG from Sigma Aldrich (BLG), rBLG according to the invention, whey protein isolate (WPI) and milk protein concentrate have been prepared and functionalization was performed to produce cold gellable protein solutions.

BLG, rBLG, WPI and milk protein concentrate in a powder form were added to deionized water to produce 5% and 7% w/w protein solutions. Solutions were stirred for 10 minutes and the pH was adjusted to pH 6.7 with HCl (1N) or NaOH (1N). The solutions were rested for 10 minutes. Solutions were then heated at 80° C. for 5, 10 or 15 minutes on hot plate (except milk protein concentrate solutions that have only been heated during 15 min), and solutions were cooled to 27° C. with an ice bath. After heating and cooling steps, solutions comprising 7% w/w proteins were diluted with demineralized water to obtain 5% w/w protein solutions.

Glucono-delta-lactone (GDL) was added to functionalized protein solutions (GDL powder was added to reach 1% w/w in solution). The resulting solutions were stirred to solubilize GDL, before letting the solutions unstirred at 27° C. in a steam room to acidify said solutions until pH 4.50 is reached and were then stored at 5° C. during 24h.

### Analysis

Gel properties were measured with TAX t Plus texturometer (Stable Microsystems) with a cylinder probe P/5 (5 mm diameter). Measurements conditions were as follow: compression step up to 15 mm at 0.5 mm/s; then return of the probe up to the surface (15 mm; 1 mm/s). Hardness is considered as the maximum force (g) during compression. The area under the curve represents the consistency (g·sec) during compression (consistency), and the maximum negative peak during probe return to surface corresponds to the stickiness. Temperature of analysis was 5° C.

### Results

Functionalized BLG and rBLG solutions were acidified to assess their cold-gelling properties. Solutions functionalized in all the conditions tested (5% and 7% w/w BLG and rBLG, with treatment at 80° C., for 5, 10 or 15 minutes) produced a gel after acidification. However, acid gels obtained from BLG were slightly more translucent compared to acid gels obtained from cold-gellable rBLG.

Texture properties of acid gels have been studied, and results are presented in table 5.

Gel hardness values obtained from functionalized bovine Sigma BLG (from 586 to 1698 g) are much higher than values of gel produced from functionalized cold-gellable rBLG (from 22 to 315 g) in all conditions of functionalization tested. Gels obtained from milk protein concentrate (total milk proteins) show even lower hardness values (from 77 to 93 g) than commercial BLG, and acid gels obtained from functionalized WPI (from 23 to 60 g) have even lower values than gels of milk protein concentrate.

C) Gelling Properties of Commercial Native Bovine BLG and rBLG after Functionalization Measured by Rheology

### General Procedure

Aqueous solutions of commercial native bovine BLG from Sigma Aldrich (BLG), rBLG according to the invention, whey protein isolate (WPI) and milk protein concentrate have been prepared and functionalization was performed to produce cold gellable protein solutions.

BLG, rBLG, WPI and milk protein concentrate in a powder form were added to deionized water to produce 5% w/w protein solutions. Solutions were stirred for 10 minutes and the pH was adjusted to pH 6.7 with HCl (1N) or NaOH (1N). The solutions were rested for 10 minutes. Solutions were then heated at 80° C. for 15 minutes on hot plate, and solutions were cooled to 27° C. with an ice bath. After heating and cooling steps, solutions comprising 7% w/w proteins were diluted with demineralized water to obtain 5% w/w protein solutions.

Appropriate amounts of Glucono-delta-lactone (GDL) in powder form were added to functionalized protein solutions to reach 1% w/w GDL in the solutions. Resulting solutions were stirred during 1 min to solubilize GDL and poured in cylinder geometry of rheometer.

### Analysis

Visco-elastic properties (Elastic modulus G′, Viscous modulus G″, loss factor Tan delta) were monitored at 27° C. as a function of time during acidification with GDL, using an Anton Paar MCR95 rheometer equipped with coaxial cylinder geometry (CC27) in oscillation mode.

Deformation was set at 1% and frequency at 1 Hz to operate in Linear Visco-Elasticity (LVE) range. The time needed for the clastic modulus (G′) to become higher than the viscosity modulus (G″) indicates gelling time. After G′ and G″ reach a plateau, they were recorded and results are presented in tables 5 and 6.

### Results

TABLE 5
Gel hardness, gelation time, elastic modulus and viscosity modulus for
acid gels obtained from commercial native bovine BLG, rBLG, WPI
and milk protein concentrate functionalized according to the invention.

| | Protein | Holding | |
|---|---|---|---|
| | concentration | time | |
| | (% w/w) | at 80 ° C. | Hardness |
| Protein | during heating step | (min) | (g) |
| Com. native | 5 | 5 | 795.4 |
| bovine BLG | | 10 | 1283.7 |
| | | 15 | 1698.4 |
| | 7 | 5 | 586.6 |
| | | 10 | 875.4 |
| | | 15 | 1165.8 |
| rBLG | 5 | 5 | 24.1 |
| | | 10 | 80.3 |
| | | 15 | 187.4 |
| | 7 | 5 | 212.3 |
| | | 10 | 315.9 |
| | | 15 | 253.2 |
| WPI | 5 | 5 | 24.6 |
| | | 10 | 23.6 |
| | | 15 | 60.1 |
| | 7 | 5 | 30.9 |
| | | 10 | 45.4 |
| | | 15 | 47.9 |
| Milk protein | 5 | 5 | N.A |
| | | 10 | N.A |
| | | 15 | 77.1 |
| | 7 | 5 | N.A |
| | | 10 | N.A |
| | | 15 | 90.9 |

N.A. means not analyzed.

TABLE 6
Gel hardness, gelation time, elastic modulus and viscosity modulus for
acid gels obtained from commercial native bovine BLG, rBLG, WPI and
milk protein concentrate functionalized according to the invention.

| | Protein | | | | | | |
|---|---|---|---|---|---|---|---|
| | concentration | Holding | | | Elastic | Viscosity | |
| | (% w/w) | time | | Gelation | modulus | modulus | Tan |
| | during | at 80° C. | Hardness | time | (G′) | (G″) | delta* |
| Protein | heating step | (min) | (g) | (s) | (Pa) | (Pa) | (G′/G″) |
| Com. | 5 | 15 | 1698.4 | 2100 | 3240 | 416 | 0.13 |
| native | | | | | | | |
| bovine | | | | | | | |
| BLG | | | | | | | |
| rBLG | 5 | 15 | 187, 4 | 700 | 950 | 160 | 0.17 |
| WPI | 5 | 15 | 60, 1 | 4300 | 53 | 14 | 0.26 |
| Milk | 5 | 15 | 77.1 | 2800 | 250 | 108 | 0.43 |
| protein | | | | | | | |

[*Tan delta is the ratio between G″ and G′, and is an indicator of the relative contribution of liquid viscous and solid elastic properties in the texture of the gel.].

Gelation time differs from one protein to another. Functionalized cold-gellable rBLG shows the shortest gelation time (700 s). High gelation time is observed for functionalized WPI (4300 s). Commercial BLG and total milk protein have gelation time of 2100 s and 2800 s respectively.

Elastic modulus of the gel differs from one ingredient to another. As expected from the hardness values, elastic modulus of acid gels from functionalized commercial BLG is much higher (3240 Pa) than for cold-gellable rBLG (950 Pa), which is also higher than elastic modulus of gel obtained from total milk proteins (250 Pa) and functionalized WPI (<100 Pa).

Tan delta that corresponds to the ratio between the elastic modulus and the viscosity modulus, gives information about the relative contribution of liquid viscous and solid elastic properties in the texture of a gel. The lower Tan delta is, the more elastic the gel is. Conversely, the higher Tan delta is, the more viscous the gel is. Tan delta at the end of gelation differs from one ingredient to another.

Values of tan delta of acid gels obtained from commercial BLG is the lowest (0.13), while the highest value is observed for the acid gel of total milk proteins (0.43). Gel produced from cold-gellable rBLG has a tan delta of 0.17), lower than the tan delta of the gel obtained from functionalized WPI (0.27).

Conclusion: results show that acid gel properties obtained from functionalized cold-gellable rBLG according to the invention are close to the properties of gels produced from functionalized WPI or total milk proteins. On the contrary, gels produced from commercial BLG have different properties.

1. A method for the preparation of cold-gellable recombinant β-lactoglobulin (rBLG) comprising the steps of:
a) providing an aqueous solution of rBLG comprising from 3 to 15% w/w rBLG, and a pH comprised between 5 and 8, and
b) heating the solution at a temperature from 65 to 95° C., for 1 to 30 minutes, to obtain the cold-gellable rBLG,
the percentage being expressed in weight in relation to the total weight of the aqueous solution.

2. The method according to claim 1, wherein the temperature of step a) ranges from 1 to 60° C.

3. The method according to claim 1, wherein step b) is conducted under agitation at a stirring speed of 1 to 500 rpm when performed in batch.

4. The method according to claim 1, wherein the method further comprises a step c) of cooling the heated aqueous solution at a temperature lower than 60° C.

5. The method according to claim 1 any one of claims 1 to 4, wherein the method further comprises step d) of concentrating the heated aqueous solution.

6. The method according to claim 1, wherein the method further comprises step e) of drying the heated aqueous solution.

7. The method according to claim 1, wherein the aqueous solution of step a) comprises rBLG and at least one polysaccharide.

8. The method according to claim 7, wherein the polysaccharide/rBLG ratio ranges from 1/3 to 1/30.

9. The method according to claim 1, wherein the rBLG is obtained from fungi, preferably from fungi of the genus Aspergillus.

10. A cold-gellable rBLG obtained from the process according to claim 1.

11. The cold-gellable rBLG according to claim 10, wherein the cold-gellable-rBLG is in the form of aggregates, said aggregates having preferably a particle size ranging from 20 to 500 nm.

12. A dry cold-gellable rBLG composition comprising 45-95% w/w cold-gellable rBLG and at least one polysaccharide.

13. The dry cold-gellable rBLG composition according to claim 12, wherein the cold-gellable rBLG is in the form of aggregates, said aggregates having preferably a particle size ranging from 20 to 500 nm.

14. An aqueous solution of cold-gellable rBLG, wherein the solution comprises from 3 to 15% w/w cold-gellable rBLG, 0.1 to 5% w/w polysaccharide and water, the percentage being expressed in relation to the total weight of the aqueous solution.

15. (canceled)
